(19) United States
(12) Patent Application Publication
(10) Pub. No.: US 2026/0311138 A1
(43) Pub. Date: Oct. 8, 2026

(54) SYSTEM AND METHOD FOR CREATING EMPLOYEE BENEFIT BOOKLETS / GUIDES

(71) Applicant: Joe S. Blascak, Waldo, OH (US)

(72) Inventor: Joe S. Blascak, Waldo, OH (US)

(21) Appl. No.: 19/688,445

(22) Filed: May 26, 2026

Related U.S. Application Data
(63) Continuation-in-part of application No. 18/120,234, filed on Mar. 10, 2023, now abandoned.
(60) Provisional application No. 63/430,429, filed on Dec. 6, 2022.

(51) Int. Cl. G06Q 10/1057

(52) U.S. Cl. CPC G06Q 10/1057

(57) ABSTRACT

An employee benefit automation platform stores renewal source materials as hashed source objects, parses them into addressable source segments, retrieves structurally similar matched samples, and creates extraction instructions requiring values supported by target sources or approved origins. Candidate benefit, rate, contribution, eligibility, carrier-response, and notice fields are normalized, checked for matched-sample leakage, source-anchored, routed for review when unsupported, and stored as approved normalized benefit records. The records generate request-for-proposal dashboards, online spreadsheets, benefit booklets, compliance documents, enrollment sites, microsites, translations, election sheets, premium breakdowns, linked artifacts, customer relationship management records, and carrier notifications. Coverage maps, dependency graphs, calculation traces, manifests, access records, tenant-scoped security contexts, signed tokens, data-egress policies, and hash-linked audit logs control reuse and publication. A publication gate blocks stale, unsupported, leakage-suspected, expired, revoked, or scope-inconsistent values.

### CROSS-REFERENCE TO RELATED APPLICATIONS

This application is a continuation-in-part of U.S. patent application Ser. No. 18/120,234, filed Mar. 10, 2023, entitled “SYSTEM AND METHOD FOR CREATING EMPLOYEE BENEFIT BOOKLETS/GUIDES,” which claims the benefit of U.S. Provisional Patent Application No. 63/430,429, filed Dec. 6, 2022. The entire disclosure of each of the foregoing applications is incorporated by reference to the extent permitted by law.

### STATEMENT REGARDING FEDERALLY SPONSORED RESEARCH OR DEVELOPMENT

No invention claimed herein was made with government support.

### STATEMENT REGARDING JOINT RESEARCH AGREEMENT

Not applicable.

### TECHNICAL FIELD

The disclosure relates to computer-implemented systems for employee benefit administration, employee benefit booklet creation, compliance document generation, plan data extraction, plan data normalization, enrollment automation, request-for-proposal workflows, spreadsheet automation, and secure publication of employee benefit information. More particularly, the disclosure relates to a multi-tenant platform that converts heterogeneous plan documents and user-provided benefit information into structured data and uses that structured data to generate booklets, compliance documents, election materials, rate breakdowns, microsites, enrollment workflows, request-for-proposal packages, and related outputs.

### BACKGROUND

Employee benefit agencies, consultants, employers, human resources departments, general agencies, professional employer organizations, and related administrators often prepare benefit communication packages for each employer group and for each plan year. Such packages can include employee benefit booklets, summary pages, carrier summaries, Summary of Benefits and Coverage documents, insurance terms and definitions, eligibility and dependent eligibility pages, rate sheets, premium breakdowns, election sheets, wrap summary plan descriptions, premium-only plan documents, broker compensation disclosures, annual legal notices, translated materials, microsite pages, and enrollment instructions.

Conventional preparation of these materials is fragmented. Plan details may arrive as carrier Portable Document Format documents, spreadsheets, email attachments, prior-year booklets, broker notes, quote packages, rate grids, or carrier-provided templates. Users frequently copy information from those sources into word processors, slide decks, spreadsheets, or manually assembled Portable Document Format documents. That process consumes time, introduces inconsistent formatting, and creates risk that benefit values, rate values, eligibility rules, carrier names, or plan limitations will be entered incorrectly.

Existing document generation systems can provide templates, but many require manual mapping of carrier documents to template fields. Generic Portable Document Format parsing can extract text but may not know how a particular carrier's plan summary should map into a benefit booklet schema. Generic language models can summarize documents but can introduce hallucinated values, omit field-specific evidence, or mix values from examples into a target plan. A technical problem therefore exists in transforming heterogeneous carrier documents into reliable structured benefit data while preserving source fidelity and while integrating that data with downstream document, enrollment, spreadsheet, customer relationship management, and request-for-proposal workflows. Generic retrieval-augmented generation workflows may retrieve example documents or previously processed samples, but without target-source-only constraints, source-anchor validation, and leakage detection, such workflows can copy example values, confuse prior-year or different-employer values with target-year values, or generate structured data that cannot be traced to a specific source page, table, row, column, coordinate region, or text span. Here are some of the main issues users face when creating these manually: Formatting/design-insurance agents (who the system is created for) are not graphic designers-they have no qualified training on how to design aesthetically pleasing communication pieces, and when they do attempt it, they take hours to build them and it still doesn't look great, or they pay someone thousands of dollars to do it. They do this because larger agencies that they compete with have their own marketing departments and produce marketing quality documents since they have the financial ability to hire graphic designers/marketers. This same thing applies for booklet translation into spanish-agencies try to do it themselves or have to pay someone thousands of dollars to do it and it takes weeks to do. Our system does it in 30 seconds. From a compliance standpoint, third parties charge hundreds to thousands of dollars to create a single WRAP SPD, grouping of mandatory legal notices or POP Document for a single company. My platform provides this capability for an agency's entire block of business at no additional cost while integrated with the other documents created-massive savings on time and money. Our spreadsheet feature also includes a web view functionality where the employer can receive the same online enrollment experience that an employee does during open enrollment; but this is to select the benefits that are offered. They have the ability to choose the plans they wish to elect and change around their contribution in real time to see their total spend in an online chassis-normally agents simply send a spreadsheet in pdf or excel to a company to review their options—this online method is a lot more efficient and has complete automation built into it to create booklets and compliance documents for the user after the employer has made their selections-game changing technology and automation.

Existing benefit booklet builders can reduce formatting burden, but downstream data often remains siloed. The same plan data may need to be re-entered for a booklet, legal notice, enrollment site, election sheet, premium breakdown, request-for-proposal spreadsheet, client microsite, and customer relationship management contact record. Disconnected tools also create audit problems: a user may not know which version of a plan Portable Document Format or which field correction produced a distributed booklet or an enrollment link.

Security and deployment concerns further complicate benefit automation. Employee benefit data may include sensitive company information, employee information, plan details, premiums, census information, dependent information, eligibility information, and billing or payment information. A platform that ingests, parses, normalizes, stores, renders, translates, and publishes such data should support role-based access, tenant isolation, tenant-scoped security contexts, secure object storage, encryption and key management, signed or tokenized publication access, network segmentation, audit logging, monitoring, and controlled external-service data egress.

There is therefore a need for a technical platform that integrates document ingestion, machine-learning-assisted extraction, source validation, canonical benefit data storage, dynamic user review, premium computation, document generation, compliance document generation, request-for-proposal/spreadsheet automation, microsite and enrollment workflow generation, and secure publication in a common multi-tenant architecture.

### SUMMARY OF THE INVENTION

The disclosed embodiments provide a computer-implemented employee benefit automation platform. In some embodiments, a user associated with a tenant organization creates or selects a company, enters company and booklet data, selects plans and output types, uploads plan documents, edits extracted benefit data, loads rates and contribution rules, and causes the platform to generate one or more final outputs. The outputs can include one or more of an employee benefit booklet, a consolidated Portable Document Format, a flipbook, a microsite, a quick-response-code-accessible link, a Spanish-language translation, a wrap summary plan description, a premium-only plan document, a broker compensation disclosure, annual legal notices, an employee election sheet, a premium breakdown sheet, a request-for-proposal package, a spreadsheet report, a customer relationship management record, and an enrollment workflow.

In some embodiments, the platform includes a source-anchored retrieval-augmented extraction engine. When a target plan Portable Document Format document, summary of benefits and coverage document, rate sheet, carrier certificate, spreadsheet, prior-year booklet, or other benefit source document is uploaded or imported, the engine stores the document as a source object having a tenant identifier, company identifier, plan-year identifier, object key, document type, and cryptographic hash. The engine parses the source object into addressable source segments, such as pages, text spans, table rows, table cells, headings, footnotes, coordinate regions, or image regions, and generates numerical vector representations from extracted text, table labels, layout metadata, plan identifiers, carrier identifiers, and candidate benefit fields. The engine retrieves one or more matched samples from a sample repository, uses the matched sample text and matched sample structured data as structural guidance, and builds an extraction instruction set requiring values for the target document to be taken from the target source segments rather than from the matched sample unless a field is expressly marked as user-entered, imported, computed, or missing. An extraction model outputs candidate structured benefit data, and a validation engine normalizes fields, checks values against target source segments, creates source anchors, assigns confidence values, flags missing or unsupported fields, and stores an approved versioned benefit record after automatic validation or reviewer approval.

In some embodiments, the validation engine also creates a source-anchor coverage map for one or more generated outputs. The source-anchor coverage map is a computer data structure that identifies, for each required output field or output component, whether the field is supported by a source anchor, user-entered origin, imported origin, computed origin, template origin, or unresolved review status. A publication gate can read the source-anchor coverage map and prevent release of an output component when a required field lacks an approved origin or when a source-document hash, approved-record version, schema version, template version, rate-calculation parameter, translation-rule-set version, or publication setting has changed after the manifest was created.

In some embodiments, the validation engine detects matched-sample leakage. A matched-sample leakage condition can exist when a candidate field value equals or substantially matches a value in a retrieved matched sample but is absent from, or not adequately supported by, the target source segments. When such a condition is detected, the platform can reject the candidate field, lower its confidence, mark the field as unsupported, store a leakage reason code, or route the field to the review queue before any generated output uses the value.

In some embodiments, a canonical benefit data model is shared by the booklet builder, compliance generator, request-for-proposal module, spreadsheet automation module, customer relationship management module, microsite generator, and enrollment site generator. A user correction made once to a plan field can therefore propagate to multiple downstream outputs without redundant data entry. The system can store source anchors, versions, and audit events so that a later reviewer can identify which uploaded document, extraction result, correction, and generation event produced a particular output.

In some embodiments, the platform uses a five-stage or multi-stage builder. A first stage receives company and output styling information, including a booklet name, plan year, contact information, logos, covers, colors, fonts, and theme selections (please note that these are all dynamic features of the system and not just something a user types in-quite a bit of coding and dynamic features built into these). A second stage receives plan selections, page selections, legal notice selections, compliance document selections, and output selections. A third stage permits the user to add, rename, duplicate, upload, delete, reorder, and library-select plans and documents. A fourth stage presents editable plan and page forms that may be prepopulated from extracted structured data and saves changes asynchronously. A fifth stage receives rates, rate types, contribution types, premium frequencies, pay periods, and employee deduction options and generates rate-related outputs.

In some embodiments, the platform improves computer operation for the specific field of benefit document generation by reducing repeated data entry, replacing brittle carrier-specific parsing rules with sample-guided extraction, preserving source-anchored evidence for structured fields, maintaining a shared canonical data store across heterogeneous outputs, and coordinating rendering, merging, translation, publication, and enrollment workflows from a common versioned state.

In some embodiments, the platform improves structured-data processing by maintaining separate but linked source-object records, source-segment records, source-anchor records, candidate-field records, approved-record versions, source-anchor coverage-map records, manifest records, publication-access records, and audit records. These linked records permit the platform to avoid reprocessing unchanged source objects, detect duplicate or superseded documents through hashes and vector representations, invalidate only outputs affected by a changed source or template, and enforce access controls at the same granularity as the source-object and output-manifest records.

In some embodiments, the platform is deployed in a cloud environment having an edge service or load balancer, a firewall or virtual private cloud boundary, one or more web or application servers, one or more relational data stores, an object document store, extraction services that parse source documents, create numerical vector representations, retrieve structurally similar samples, and assign target-source-supported field values, a key-management or secrets-management service, and security telemetry services. The platform can exchange data with external services such as payment processors, translation services, email services, Portable Document Format parsing services, language model services, payroll systems, carrier systems, analytics systems, and monitoring services while maintaining tenant isolation, role permissions, logging, tenant-specific data-egress controls, controlled access to stored documents, and manifest-linked publication access.

In some embodiments, the platform maintains a source-to-output provenance graph linking a source object, a source segment, a source anchor, a candidate structured benefit field, a reviewer action, a canonical benefit record, and each generated output component. The provenance graph can be used to determine whether an output component is supported by an uploaded or imported source, whether a field was edited by a user, whether a later source version affects a previously generated output, and whether regeneration or review is required before publication.

In some embodiments, successful authentication creates a tenant-scoped security context that travels with ingestion, parsing, extraction, validation, review, rendering, translation, enrollment, publication, and administrative operations. Background jobs may use signed capability tokens that identify the tenant, company, source object, approved-record version, permitted operation, requesting user or service principal, and expiration time. Published artifacts may be accessed through signed links, employee-specific tokens, role-protected sessions, or tenant-scoped access grants that are checked against manifest state, expiration, revocation, and approved-record versions. External-service calls may be filtered through tenant-specific data-egress policies that redact or tokenize sensitive data, and manifest and audit records may be stored in an append-only or hash-linked log so that unauthorized alteration, stale publication, or unauthorized access can be detected.

### BRIEF DESCRIPTION OF THE DRAWINGS

FIG. 1 is a block diagram showing a secure benefit automation platform environment according to exemplary embodiments.

FIG. 2 is a block diagram showing software modules and shared data stores of the platform according to exemplary embodiments.

FIG. 3 is a flow chart showing an integrated benefit output workflow according to exemplary embodiments.

FIG. 4 is a flow chart showing a source-anchored retrieval-augmented extraction flow according to exemplary embodiments.

FIG. 5 is a flow chart showing a renewal-project state machine, renewal dependency graph, change-impact engine, and publication-gate status evaluation according to exemplary embodiments.

FIG. 6 is a block diagram showing a carrier-facing request-for-proposal dashboard, line-of-coverage segmentation, carrier invite records, carrier response source-object ingestion, and carrier status-event recording according to exemplary embodiments.

FIG. 7 is a flow chart showing a dynamic online spreadsheet scenario engine, employer decision approval, census and rate calculations, and propagation of an approved spreadsheet scenario to booklet, enrollment, election-sheet, premium-breakdown, microsite, and carrier-notification outputs according to exemplary embodiments.

FIG. 8 is a flow chart showing manifest-bound publication, source-anchor coverage-map evaluation, legal-notice freshness checking, signed or tokenized access, stale-output invalidation, and selective regeneration, revocation, expiration, or revalidation of affected output components according to exemplary embodiments.

### DETAILED DESCRIPTION

The following detailed description describes exemplary embodiments with reference to the drawings. The embodiments are illustrative and are not limiting. Features described with respect to one embodiment may be combined with features described with respect to other embodiments unless the context clearly indicates otherwise. Operations described as being performed by a module may be performed by one or more processors executing instructions stored in one or more non-transitory memories, by distributed services, by client-side code, by server-side code, or by any suitable combination thereof.

As used herein, a “tenant” can include an agency, employer, broker, general agency, professional employer organization, association, carrier-facing organization, or other organization using the platform. A “user” can include an administrator, enterprise super user, enterprise user, agency user, agent, employer administrator, human resources user, carrier user, employee, enrollment participant, developer, or other authenticated or invited actor. A “company” can include an employer group, client, prospect, division, association, or other entity for which benefit information is created, stored, quoted, published, or enrolled.

As used herein, a “benefit plan” includes any plan, coverage, policy, product, option, package, or benefit offering, including without limitation medical, dental, vision, life, disability, accident, critical illness, hospital indemnity, supplemental health, health savings account, health reimbursement arrangement, flexible spending account, commuter benefit, legal benefit, identity-theft benefit, wellness program, telemedicine, voluntary worksite benefit, retirement-related benefit, or other benefit. A benefit plan may have multiple options, tiers, networks, rate structures, employer contribution structures, eligibility rules, carrier documents, and compliance obligations.

As used herein, a “benefit output” includes any generated or assembled artifact containing benefit information or derived from benefit information. Benefit outputs include booklets, guides, pages, tables, Portable Document Format documents, editable Portable Document Format documents, flipbooks, links, quick-response-code pages, microsites, enrollment pages, request-for-proposal packages, spreadsheet reports, rate grids, election sheets, premium breakdowns, annual legal notices, wrap summary plan descriptions, premium-only-plan documents, broker compensation disclosures, carrier termination letters, compliance notices, translated versions, and other electronic or printed materials.

As used herein, a “Portable Document Format document” means a file, image, or document representation in a portable document format or comparable fixed-layout document format. A “summary of benefits and coverage document” means a carrier, employer, or administrator document that summarizes plan benefits, coverage limitations, costs, or coverage levels. A “request-for-proposal artifact” means a questionnaire, spreadsheet, package, comparison, link, response record, or other carrier-marketing or vendor-marketing output. A “customer relationship management record” means a company, contact, agent, employer, employee, opportunity, task, note, renewal, or enrollment record used to manage client relationships or workflows. A “quick response code” means a machine-readable code that directs a user device to a platform link or resource.

As used herein, “retrieval-augmented extraction” means a computer process in which a target source object or segment is embedded or otherwise represented, one or more similar samples are retrieved from a sample repository, and the retrieved sample information is used as structural guidance for extracting values from the target source object. A “language model” or “extraction model” means a machine-learning model, rule-constrained model, hosted model, private model, or hybrid model configured to generate or classify structured data from text, tables, images, or document features.

As used herein, “structured benefit data representation” means any structured representation of plan information. The representation may use Javascript Object Notation, extensible markup language, a relational record, a graph, a key-value store, a typed object, a protocol buffer, a spreadsheet row, or any equivalent structure. A “wrap summary plan description” means a document or output that combines plan information with summary-plan-description content. A “premium-only-plan document” means a document or output relating to a premium-only plan. “Security information and event management” and “monitoring and management agent” refer to telemetry, monitoring, endpoint, or event-collection functionality for security or operational review.

As used herein, a “source anchor” means stored evidence linking a structured field or generated output value to an uploaded or imported source object or to a permitted non-source origin. A source anchor may include a source-object identifier, cryptographic hash, page number, table identifier, row identifier, column identifier, coordinate region, character range, extracted text excerpt, parser version, schema field identifier, and validation status. A “source-anchor coverage map” means a data structure that associates required fields, optional fields, output components, or generated pages with source anchors, origin types, confidence values, review statuses, rule identifiers, and blocking statuses.

As used herein, a “manifest data record” means a stored record linking a generated output or output package to source-object identifiers, source-document hashes, approved-record versions, schema versions, template versions, parser versions, extraction-instruction versions, model identifiers, rate-calculation parameters, translation-rule-set versions, source-anchor coverage maps, reviewer approvals, output hashes, publication links, access permissions, expiration states, and revocation states. A “publication gate” means logic that evaluates manifest data, source-anchor coverage-map data, review-queue state, completeness rules, security context, and publication-access state before a generated output is published, served, exported, linked, or made available to an employee-facing or employer-facing user.

As used herein, a “security context” means a tenant-scoped and user-scoped or service-principal-scoped set of authentication and authorization attributes used by the platform to control database queries, object-storage operations, source ingestion, extraction, review, output generation, enrollment, publication, application programming interface access, external-service calls, and administrative actions. A “capability token” or “signed work token” means a signed or otherwise verifiable authorization artifact issued for a specific background job or service operation. A “data-egress policy” means tenant-specific rules for determining whether data may be transmitted to an external service and what redaction, tokenization, minimization, consent, endpoint, retention, model-use, logging, or audit requirements apply. A “matched-sample leakage condition” means a condition in which a candidate value appears to have been copied, inferred, or carried over from a matched sample, prior-year record, or example record without adequate support in target source segments or another approved origin.

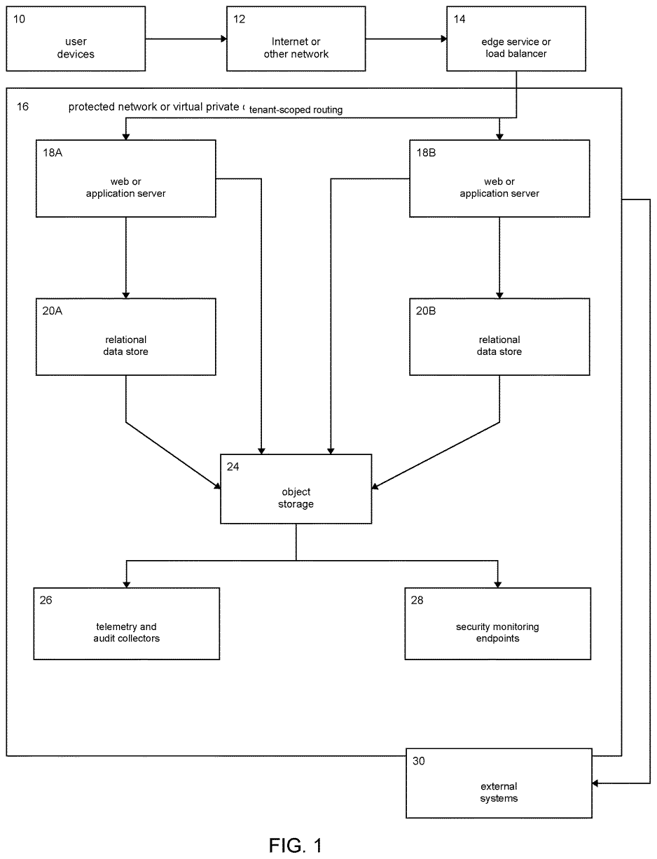

FIG. 1 illustrates an exemplary secure benefit automation platform environment. User devices 10 access the platform through an Internet or other network 12 and an edge service or load balancer 14. The edge service can include a content delivery network, web application firewall, reverse proxy, transport layer security termination point, rate limiter, or bot-protection service. Traffic can be routed into a protected network or virtual private cloud 16 to one or more web or application servers 18A and 18B. The application servers can exchange data with relational data stores 20A and 20B and object storage 24. Telemetry and audit collectors 26 can receive request logs, parser events, extraction events, reviewer actions, output-generation events, publication events, access events, and security events. Security monitoring endpoints 28 can include endpoint protection, monitoring agents, security information and event management integrations, anomaly detection services, alerting services, or managed security tools. External systems 30 can provide payment processing, email, text-message, translation, Portable Document Format parsing, language model inference, analytics, enrollment, payroll, carrier, or other integrations.

Referring still to FIG. 1, the edge service or load balancer 14 may terminate transport layer security, route requests to healthy application servers, apply tenant-aware or endpoint-aware routing rules, limit excessive requests, and reject requests that fail configured access controls. The protected network or virtual private cloud 16 may isolate application servers 18A and 18B from public database access, restrict database servers 20A and 20B to application-layer connections, restrict object storage 24 to authenticated service principals, signed worker capability tokens, or signed links, and forward audit and telemetry records to telemetry and audit collectors 26 and security monitoring endpoints 28. These controls permit sensitive benefit source documents, generated benefit outputs, employee election records, and customer relationship management records to be processed while preserving tenant isolation and source-object accountability.

Object storage 24 can store uploaded Portable Document Format documents, parsed text artifacts, generated Portable Document Format documents, spreadsheets, images, translated outputs, flipbook assets, source-object hashes, and output artifacts under tenant-specific object keys. Source documents, parsed artifacts, generated outputs, translated outputs, spreadsheet artifacts, enrollment records, and manifest records may be encrypted at rest using envelope encryption. A tenant-level, company-level, source-object-level, output-level, or artifact-level data encryption key may be generated, wrapped, rotated, disabled, or destroyed using a key-management service. Database servers 20A and 20B can store relational metadata, canonical benefit records, field provenance, user permissions, workflow state, publication status, key identifiers, key versions, and output manifests. The application servers 18A and 18B can coordinate database transactions and object-storage writes so that a generated output references the source-object versions, key identifiers, and template versions actually used to render that output. Generated outputs can be stored in object storage 24, transmitted through external systems 30, published through tenant-scoped links, or made available through employee-facing or employer-facing workflows according to publication settings.

In one implementation, the web application is implemented using a server-side web framework with server-rendered templates, browser scripts, asynchronous browser-to-server requests, and relational database persistence. A relational database may store users, roles, companies, plans, templates, rates, generated document metadata, and audit events. Document storage may use object storage, cloud drive storage, or local storage. Portable Document Format rendering may use a rendering package, Portable Document Format assembly may use a merger and parser, and spreadsheet import and export may use a spreadsheet library. The foregoing technologies are examples only; the platform can be implemented in other programming languages, database systems, storage systems, and rendering systems.

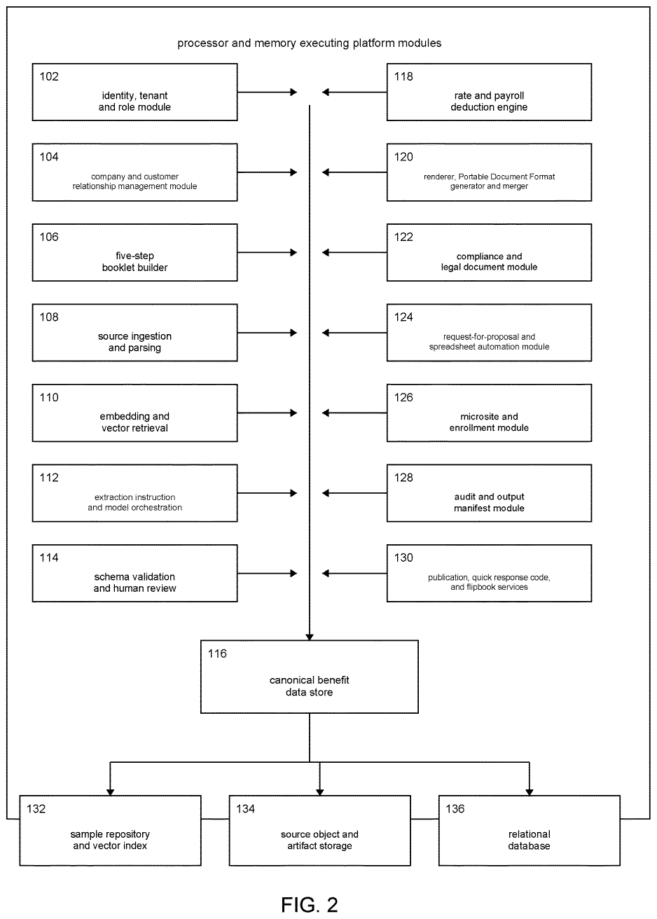

FIG. 2 illustrates platform modules and shared data stores. A processor and memory 100 execute an identity, tenant, and role module 102; a company and customer relationship management module 104; a five-step booklet builder 106; a source ingestion and parsing module 108; an embedding and vector retrieval module 110, where an embedding is a numerical vector representation of text, table, layout, field, carrier, plan, or document content; an extraction instruction and model orchestration module 112; a schema validation and human review module 114; a canonical benefit data store 116; a rate and payroll deduction engine 118; a renderer, Portable Document Format generator, and merger 120; a compliance and legal document module 122; a request-for-proposal and spreadsheet automation module 124; a microsite and enrollment module 126; an audit and output-manifest module 128; and publication, quick-response-code, and flipbook services 130. A sample repository and vector index 132 store previously processed sample documents, sample text, structured sample field records, numerical vector representations, schema versions, reviewer correction history, quality scores, and permission metadata. Source object and artifact storage 134 stores uploaded documents, parsed artifacts, generated documents, translated outputs, publication assets, and output files. A relational database 136 stores tenant, user, company, plan, rate, benefit-field, enrollment, customer relationship management, request-for-proposal, spreadsheet, generated-output, workflow-state, source-anchor, manifest, and audit-event records.

The modules shown in FIG. 2 may be deployed as a monolithic web application, a set of microservices, a serverless workflow, containerized services, client-side modules, cloud functions, or a hybrid of those arrangements. A module may call a remote service through an application programming interface, may execute locally on a server, may execute in a worker queue, or may execute in a browser or mobile application. For example, a document parser may be a remote parsing application programming interface, an internal parser, a worker process, an optical character recognition service, or a hybrid parser. A language model may be remote, private, self-hosted, fine-tuned, supplied with retrieved sample text and schema context, rule-constrained, or locally executed.

The identity, tenant, and role module 102 authenticates users, assigns permissions, restricts access to companies and documents, and determines which screens, actions, and outputs a user may access. Example roles include administrator, enterprise super user, enterprise user, agency owner, agency administrator, agent, employer administrator, carrier user, developer, employee, and limited viewer. Role permissions can determine whether a user may create companies, add agents, view payments, manage pricing packages, view analytics, create booklets, create compliance documents, create enrollment sites, run request-for-proposal workflows, upload plan documents, approve machine-learning extraction results, invite employees, access source anchors, invoke external services, revoke publication links, or publish outputs.

In some embodiments, successful authentication creates a security context comprising a tenant identifier, user identifier, role identifier, permitted company scope, permitted document scope, permitted output scope, session identifier, authentication assurance level, issued-at time, expiration time, and one or more policy identifiers. The platform applies the security context to database queries, object-storage operations, sample-repository retrieval, extraction runs, review-queue actions, output generation, translation actions, publication actions, application programming interface requests, administrative operations, and external-service calls. A request is rejected when the tenant identifier, company identifier, source-object identifier, approved-record version identifier, manifest identifier, output identifier, or employee identifier does not match the permissions encoded in or associated with the security context.

Authentication can be performed using password credentials, single-sign-on credentials, Security Assertion Markup Language credentials, OpenID Connect credentials, Open Authorization protocol credentials, passkeys, magic links, certificates, service-principal credentials, application programming interface keys, multi-factor authentication, or any combination thereof. The platform may require step-up authentication before publishing an output, approving an extraction, exporting employee or dependent data, changing tenant data-egress policy, changing key-management policy, revoking another user's session, or invoking a high-risk administrative route.

For asynchronous parsing, embedding, retrieval, model invocation, validation, rendering, merging, translation, spreadsheet import, publication, notification, enrollment export, and audit tasks, the platform may issue a signed work token or capability token identifying a tenant, company, source object, approved-record version, manifest, permitted operation, requesting user or service principal, job identifier, issued-at time, expiration time, and policy version. A worker validates the token before accessing a source object, sample repository, extraction model endpoint, object store, database record, generated output, publication service, or external service. The worker may refuse execution when a source hash, approved-record version, tenant identifier, revocation state, or permission state differs from the state represented when the job was created.

The company, customer relationship management, and contact module 104 stores company name, tax identification number, address, city, state, postal code, employer contacts, human-resources contacts, agency contacts, carrier contacts, phone numbers, emails, plan year, renewal dates, divisions, classes, groups, employees, dependents, agents, tasks, notes, opportunities, request-for-proposal status, enrollment status, and document links. Company records may be created manually, from bulk upload spreadsheets, from customer relationship management integration, from enrollment intake forms, from copied prior-year records, or from imported templates.

The five-step booklet builder 106 coordinates a user-facing workflow for generating benefit outputs. The spreadsheet builders use specifically 5 steps to ease the burden of the user and this templated structure is what creates the usefulness of this system and separates it from open source type products. The workflow can be linear, conditional, reentrant, saved for later, cloned, branched, or automatically prepopulated from prior records. Users may return to previous steps to edit, preview, save, copy, translate, publish, or regenerate outputs.

Representative data objects are listed in Table 1. The exact schema may vary. Fields may be added, omitted, denormalized, encrypted, tokenized, indexed, versioned, or stored as a structured data representation according to implementation needs.

TABLE 1
Representative Data Objects

| Object | Representative Contents |
|---|---|
| Tenant | Organization, permissions, subscription plan, |
| | branding, security settings, data-egress |
| | policies, key-management settings, signed- |
| | link settings, external integrations. |
| User | Identity, role, authentication state, |
| | authentication assurance level, security |
| | context, contact information, permitted |
| | companies, audit metadata. |
| Company | Employer or client profile, plan year, |
| | contacts, tax and address fields, renewal |
| | status. |
| Plan | Coverage category, carrier, plan name, |
| | network, benefit fields, rate structure, |
| | contribution rules. |
| PlanDocument | Uploaded Portable Document Format |
| | document, summary of benefits and coverage |
| | document, rate sheet, certificate, carrier |
| | document, source hash, storage reference. |
| BenefitField | Canonical field key, value, normalized value, |
| | source page or table, confidence, validation |
| | status. |
| RateGrid | Premium frequency, rate type, contribution |
| | type, tiers, age bands, employer contribution, |
| | deduction output. |
| BookletSection | Selected page, order, section type, template, |
| | visibility rules, generated component |
| | reference. |
| ComplianceDocument | Document type, required fields, legal notice |
| | selections, generated Portable Document |
| | Format document, version. |
| RequestForProposalProject | Requested coverages, census, questionnaire, |
| | carrier targets, quote responses, comparison |
| | outputs. |
| EnrollmentSite | Hosted workflow, eligibility rules, plan |
| | choices, employee election state, |
| | confirmation receipts. |
| AuditEvent | Actor, action, object, before/after values, |
| | timestamp, Internet Protocol/session data, |
| | security context, source document, manifest |
| | hash, prior-event hash, result. |

In Step 1 of an exemplary workflow, the platform receives company and booklet information. Inputs can include booklet name, plan year, employer name, employer address, contact names, phone numbers, emails, agency information, carrier information, logos, cover image, back cover image, theme, font selection, color scheme, quick response code settings, microsite settings, and language preferences. A theme may include a cover layout, table layout, section heading style, page border, icon set, typography, stock images, logo placement, and back cover arrangement. Users may choose preset colors or enter color values.

In Step 2, the platform receives selections of plans, pages, annual notices, legal notices, and compliance documents. Plan selections can include individual plan categories, combination pages, dual or triple plan layouts, side-by-side comparison pages, or custom page groups. Page selections can include insurance terms and definitions, important items to remember, notes, table of contents, page numbers, health savings account, health reimbursement arrangement, flexible spending account, commuter benefit, legal benefit, disability benefit, life benefit, accident benefit, critical illness benefit, hospital indemnity benefit, identity-theft benefit, wellness program, and other reusable page types. Legal notices can include Children's Health Insurance Program notices, Consolidated Omnibus Budget Reconciliation Act notices, Health Insurance Portability and Accountability Act notices, Medicare Part D notices, wellness program disclosures, Women's Health and Cancer Rights Act notices, Michelle's Law notices, Genetic Information Nondiscrimination Act notices, marketplace notices, and other annual notices. Compliance selections can include wrap summary plan description, premium-only-plan documents, carrier termination letters, broker compensation disclosures, Non Discrimination Testing (NDT), CMS reporting for Medicare creditability and related documents.

In Step 3, the platform permits plan and document customization. A user may add a new plan from a list of available plans, rename a plan, duplicate a plan, copy a prior-year plan, add a custom plan, upload a Portable Document Format, upload a rate sheet, upload a certificate, choose a document from a Portable Document Format library, create folders or subfolders, delete a selected plan or page, or change the order of pages using drag-and-drop functionality. The system can dynamically update a table of contents and page numbers when the order changes. The system may also store uploaded documents in a library so they can be reused by other companies or booklets within the same tenant according to permissions.

In some embodiments, the Portable Document Format library stores frequently used external Portable Document Format documents. A user can create folders and subfolders, upload documents, preview documents, apply tags, restrict access, select a document for inclusion in a booklet, and arrange the document with generated pages. The platform can store document hashes and version metadata so that if a document is replaced, prior generated outputs can be associated with the prior version.

In Step 4, the platform displays forms and tabs for entering plan and page information. The fields displayed may depend on the selections in Step 2 and the documents uploaded in Step 3. For a selected plan, the system can display carrier name, plan name, page name, page explanation, plan information, benefit rows, in-network values, out-of-network values, notes, prescription drug tiers, deductible amounts, out-of-pocket maximums, copayments, coinsurance, emergency room values, urgent care values, lab values, imaging values, inpatient values, outpatient values, specialty drug values, eligibility text, exclusions, limitations, and carrier contact data. A user may disable a row, add a row, edit a label, add a description, update a font size, apply formatting, change images, save a plan for reuse, or load a plan from a library.

The Step 4 interface may be dynamic and asynchronous. When a user enters or changes a field, client-side code can send an asynchronous browser-to-server or other asynchronous request to a server route. The server can validate the field, update a database record, update a structured-data field, store an audit event, and return a confirmation or error. The interface can preserve work during extended editing sessions, reduce loss from timeouts, and permit previewing a plan or page without regenerating the entire booklet.

In Step 5, the platform receives premium and contribution information. Inputs can include premium frequency, employee deduction frequency, rate guarantee, number of pay periods per year, rate type, contribution type, contribution rules, monthly premium amounts, employer contribution amounts, employee contribution amounts, tier labels, age bands, composite rates, class-based rates, coverage classes, tobacco status, spouse status, dependent child counts, life volume, disability volume, and other fields. The platform can calculate employee deduction amounts, employer monthly contributions, employer annual contributions, employee monthly contributions, per-paycheck deductions, total premium, and comparison values.

Representative rate types and contribution types are listed in Table 2. The system is not limited to these types and can support custom rate logic, configured formulas, imported tables, or carrier-specific grids.

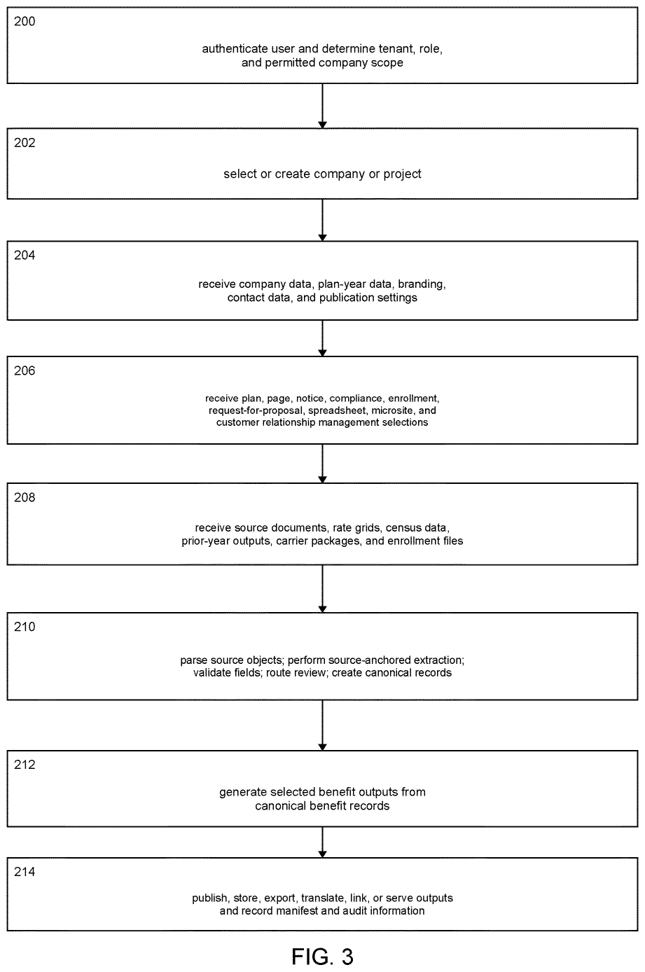

FIG. 3 illustrates an integrated benefit output workflow. At block 200, the platform authenticates a user and determines a tenant, role, and permitted company scope. At block 202, the user selects or creates a company or project. At block 204, the platform receives company data, plan-year information, branding selections, contact data, cover selections, language preferences, and publication settings. At block 206, the platform receives selections of plans, pages, notices, compliance documents, enrollment features, request-for-proposal artifacts, spreadsheet artifacts, microsite features, or customer relationship management records. At block 208, the platform receives uploaded or imported source documents, rate grids, census data, prior-year outputs, carrier quote packages, legal notice inputs, or enrollment files. At block 210, the platform parses source objects, performs source-anchored extraction, validates fields, routes unsupported fields for review, and creates or updates canonical benefit records. At block 212, the platform generates selected benefit outputs from the canonical benefit records. At block 214, the platform publishes, stores, exports, translates, links, or otherwise makes available the generated outputs and records output-manifest and audit information.

TABLE 2
Representative Rate and Contribution Types

| Category | Examples |
|---|---|
| Rate types | Two-tier composite, three-tier composite, |
| | four-tier composite, eight-tier composite, |
| | Affordable Care Act rates, age-banded rates, |
| | life rates, disability rates, accident rates, |
| | critical illness rates, hospital indemnity rates, |
| | custom imported rates. |
| Contribution types | Percent contribution, fixed dollar |
| | contribution, total dollar contribution, tier- |
| | specific percentage, tier-specific fixed dollar |
| | contribution, employee-only contribution, |
| | employer-paid contribution, class-based |
| | contribution, custom formula. |
| Output calculations | Employee deduction per paycheck, employer |
| | contribution per month, employer |
| | contribution per year, employee contribution |
| | per month, total premium, contribution ratios, |
| | premium breakdown, election sheet values. |

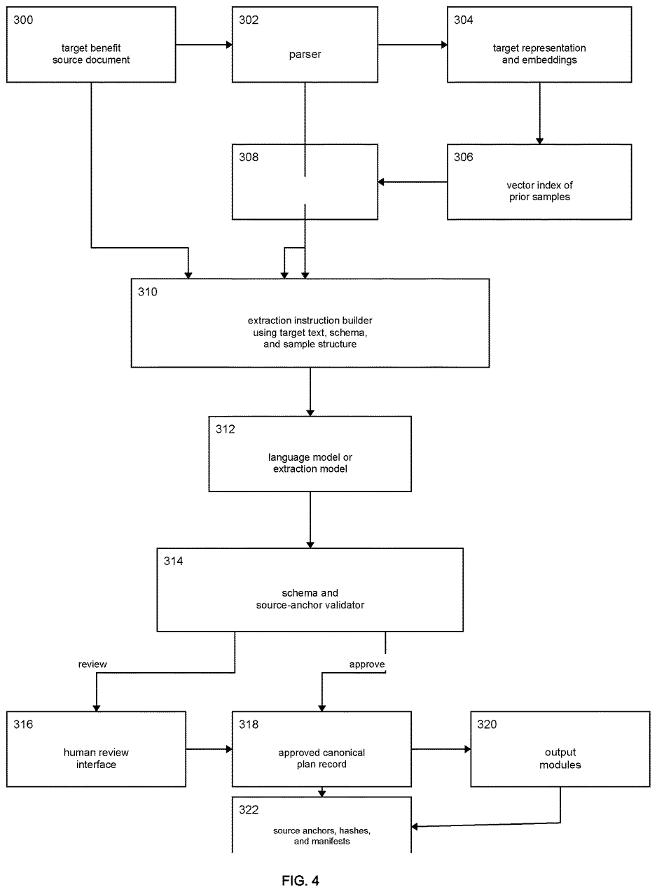

FIG. 4 illustrates a source-anchored retrieval-augmented extraction flow. A target Portable Document Format, summary of benefits and coverage, rate sheet, plan summary, certificate, or other benefit document 300 is uploaded or otherwise received. A parser 302 extracts text, tables, page identifiers, coordinate information, column headings, row labels, benefit values, and other features. Extraction can use optical character recognition, embedded text extraction, table recognition, layout analysis, regular expressions, document machine learning, heuristic parsing, carrier-specific parsing, or any suitable combination.

A target representation and embeddings 304 are generated, the embeddings being numerical vector representations used to compare text, table, layout, or metadata content. The target representation may include the entire extracted text, selected chunks, table rows, headings, carrier names, plan names, date fields, benefit categories, or a numerical vector representation of the document or its portions. The system may use a vector index of prior samples 306. The index can store numerical vector representations of sample Portable Document Format documents, sample extracted text, sample structured data representation, plan type metadata, carrier metadata, coverage category metadata, and performance metadata. A library may include sample documents previously approved by users, internally curated samples, carrier-specific samples, tenant-specific samples, or public carrier forms.

A retrieval module identifies a matched sample 308, or multiple candidate samples, based on semantic similarity, carrier similarity, plan category, form layout, effective date, field coverage, table labels, or a weighted retrieval score. In one implementation, the index is implemented using a vector similarity library. In other implementations, the index may be implemented using a database vector extension, an approximate nearest neighbor engine, a search engine, a semantic cache, a graph, or a hybrid keyword and vector retrieval method.

An extraction instruction builder 310 then combines target extracted text, matched sample text, matched sample structured data, the canonical benefit schema, and extraction rules. The extraction rules can instruct the language model that field values must be extracted from the target document, that the sample structured data is used for structure and formatting but not for target values, that missing fields should be marked as missing rather than invented, that ambiguous fields should be flagged, that output must conform to a schema, and that values should be returned with source page or table references when possible.

A language model or extraction model 312 generates a structured benefit data representation. The model may be a large language model, domain-specific language model, fine-tuned model, local model, remote application programming interface model, multimodal model, table model, rule-based extraction engine, classifier, optical-character-recognition-assisted extractor, or ensemble. The model may receive a system extraction instruction and a user extraction instruction. The system extraction instruction can define the model's role as a benefit plan Portable Document Format-to-structured data representation extractor and can prohibit use of values not found in the target source. The user extraction instruction can include the sample Portable Document Format text, the sample structured data, and the target Portable Document Format text. The model output can include carrier name, plan name, in-network deductible, out-of-network deductible, office visit copay, specialist copay, emergency room copay, urgent care copay, out-of-pocket maximum, coinsurance, prescription drug tiers, preventive care values, inpatient values, outpatient values, health savings account eligibility, effective date, and other structured fields.

A schema and source-anchor validator 314 receives the model output. The schema and source-anchor validator can coerce values to canonical units, normalize currency, remove thousands separators or add them according to display rules, normalize percentage values, map synonyms, validate plan category, compare values against target source text, detect unsupported values, identify missing required fields, assign confidence, and create source anchors. Source anchors can include page number, table identifier, source string, bounding box, text span, paragraph identifier, character offset, coordinate value, source-object identifier, or document hash. If a value is not supported by the target source, the validator can flag the field for review, set confidence below a threshold, or reject the value.

The schema and source-anchor validator 314 may also create a source-anchor coverage map. For example, the validator may identify all fields required by a selected booklet page, compliance document, enrollment page, spreadsheet export, election sheet, premium breakdown, request-for-proposal artifact, or microsite page and may assign each required field a status such as source-anchored, user-entered, imported, computed, template-derived, missing, conflicted, low-confidence, leakage-suspected, or review-approved. The coverage map can be stored with the approved canonical plan record, output manifest, or publication-access record and can be re-evaluated when a source object, template, schema, rate parameter, translation rule, or publication setting changes.

In some embodiments, the validator compares normalized candidate values against normalized matched-sample values and against normalized target source segments. If a candidate value is present in a matched sample but not in a target source segment or approved non-source origin, the validator may mark a matched-sample leakage condition. The validator may store a leakage event comprising the candidate field identifier, matched-sample identifier, candidate value, matched-sample value, target-evidence score, normalization method, reason code, and review disposition.

A human review interface 316 can show extracted values, field labels, confidence, source snippets, source pages, side-by-side target Portable Document Format views, matched sample information, warnings, and proposed corrections. A user may approve, correct, reject, or override a field. The platform can store the user correction, the original model output, the source evidence, the reviewer identity, and a timestamp. Approved data becomes an approved canonical plan record 318.

The approved canonical benefit record 318 can drive output modules 320. The output modules 320 can include booklet generators, compliance document generators, request-for-proposal generators, spreadsheet generators, enrollment-site generators, microsite generators, translation services, quick-response-code link services, flipbook services, customer relationship management record writers, election sheet generators, premium breakdown generators, and publication services. Source anchors, hashes, and manifests 322 preserve traceability from each generated output back to the source object, source-document hash, source segment, approved canonical benefit record, schema version, template version, reviewer approval, and output identifier. When a user approves an extracted plan and the plan is sufficiently complete, corrected target text and approved structured data may be added to the sample repository, subject to tenant permissions and privacy rules, so that future similar documents can be matched more accurately.

The source-anchored retrieval-augmented extraction flow solves a specific technical problem in benefit automation. Carrier documents vary in layout and terminology, and a static parser can fail when a table layout changes. By retrieving a similar sample and providing its structured data representation as a formatting and field-mapping guide, the language model can map a new target document to a canonical schema with less custom code. By requiring target-source values and performing validation against source evidence, the system reduces the risk that sample values or language model assumptions will be substituted for target values. The leakage-detection and coverage-map operations further reduce the risk that a structurally similar example, prior-year booklet, or different company document supplies a value that is later published without target-source support.

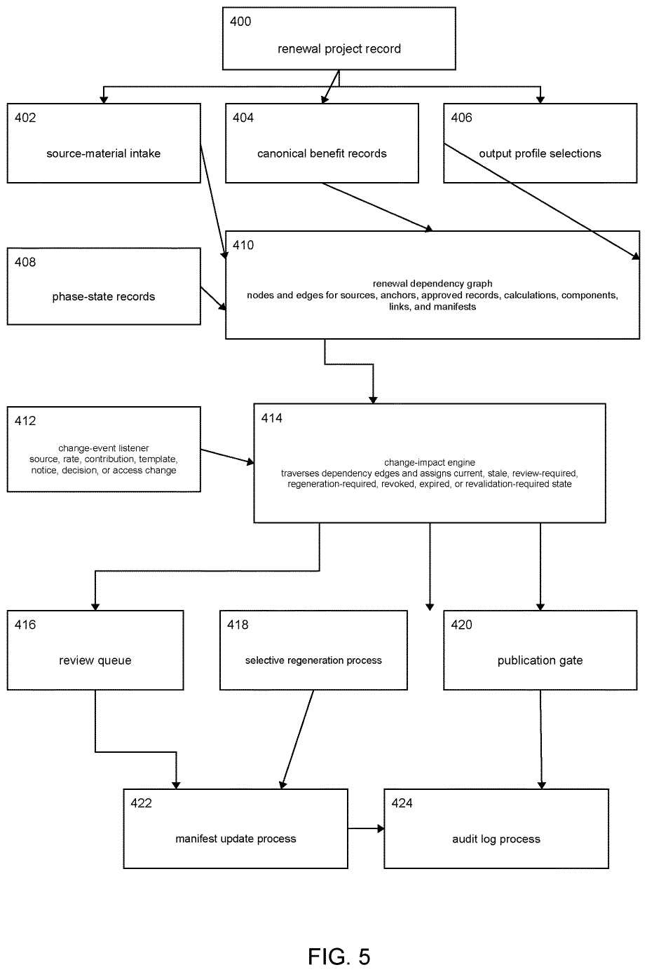

FIG. 5 illustrates an exemplary renewal-project state machine, renewal dependency graph, change-impact engine, and publication-gate status evaluation. A renewal project record 400 is created or selected for a tenant organization, company, and plan year. Source-material intake 402 receives source objects, census records, rate grids, prior-year outputs, carrier contacts, employer contribution inputs, and legal-notice inputs. Canonical benefit records 404, output profile selections 406, and phase-state records 408 are associated with the renewal project. A renewal dependency graph 410 stores nodes and edges linking source objects, source anchors, approved normalized benefit records, rate calculations, spreadsheet scenarios, compliance templates, output components, enrollment screens, publication links, and manifest records.

Referring still to FIG. 5, a change-event listener 412 can receive a change to a source-document hash, carrier response, rate value, contribution rule, employer decision, compliance template, legal-notice version, approved-record version, publication setting, or access record. A change-impact engine 414 traverses dependency-graph edges, such as derived-from, calculated-from, rendered-from, selected-by, access-controlled-by, superseded-by, translated-from, or published-from edges, and assigns affected components to states including current, stale, review-required, regeneration-required, access-revoked, expired, revalidation-required, or unaffected. Review queue 416, selective regeneration process 418, publication gate 420, manifest update process 422, and audit log process 424 then coordinate publication blocking or release.

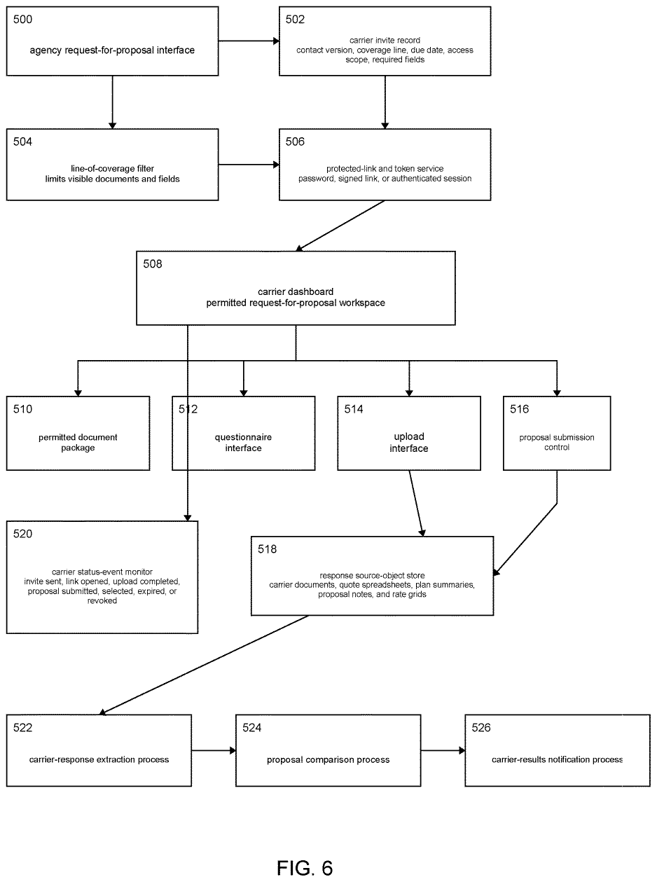

FIG. 6 illustrates an exemplary carrier-facing request-for-proposal dashboard and related source-object ingestion flow. An agency request-for-proposal interface 500 creates a carrier invite record 502 associated with a carrier contact version, requested coverage line, due date, access scope, required questionnaire fields, permitted source documents, permitted upload types, password or token requirement, expiration setting, and status state. A line-of-coverage filter 504 limits which documents and questionnaire fields are visible to a carrier user. A protected-link and token service 506 generates a password-protected, signed, tokenized, or authenticated-session-based access path to a carrier dashboard 508.

Referring still to FIG. 6, the carrier dashboard 508 can present a permitted document package 510, questionnaire interface 512, upload interface 514, and proposal submission control 516. Carrier response documents, quote spreadsheets, plan summaries, proposal notes, and rate grids are stored by a response source-object store 518 as source objects associated with the renewal project. A carrier status-event monitor 520 records invite-sent, link-opened, document-downloaded, questionnaire-started, upload-completed, proposal-submitted, clarification-requested, proposal-approved, proposal-selected, proposal-not-selected, invite-expired, and invite-revoked events. Carrier-response extraction process 522, proposal comparison process 524, and carrier-results notification process 526 can then use the same source-anchor, canonical-record, manifest, and dependency-graph controls used for agency-provided source materials.

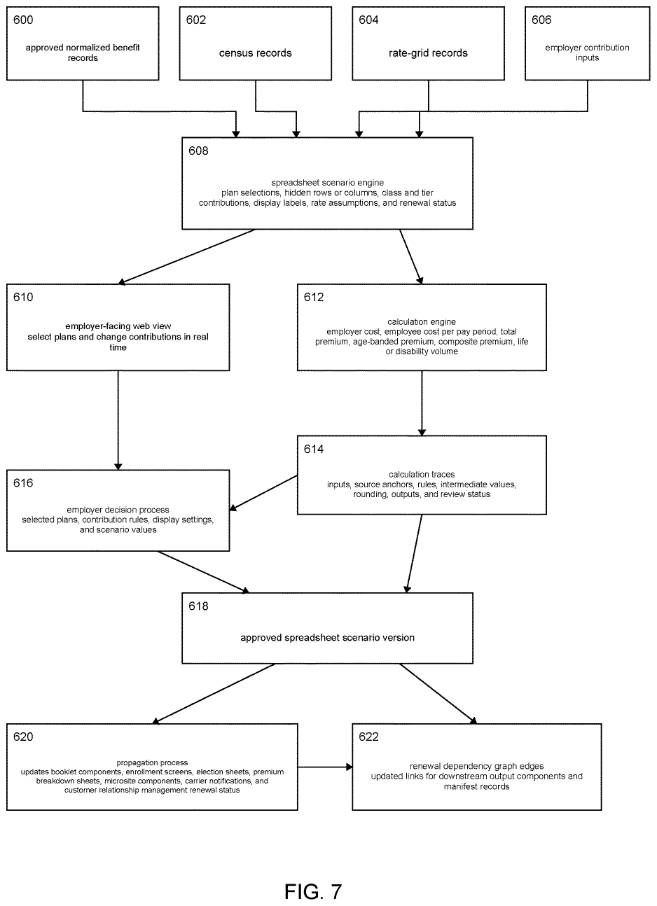

FIG. 7 illustrates an exemplary dynamic online spreadsheet scenario engine, employer decision workflow, census and rate calculation flow, and downstream propagation process. Approved normalized benefit records 600, census records 602, rate-grid records 604, and employer contribution inputs 606 are provided to a spreadsheet scenario engine 608. The spreadsheet scenario engine 608 generates an employer-facing web view 610 that may include selected plans, hidden-plan settings, hidden-row settings, hidden-column settings, class-specific contribution fields, tier-specific contribution fields, display labels, rate assumptions, waiver assumptions, renewal-status fields, and comparison fields.

Referring still to FIG. 7, a calculation engine 612 calculates employer monthly cost, employer annual cost, employee monthly contribution, employee cost per pay period, total premium, age-banded premium, composite premium, tier-based premium, life benefit volume, disability benefit volume, or difference-from-current-plan values. Calculation traces 614 identify input fields, source anchors or approved origins, rule versions, intermediate values, output values, rounding rules, and reviewer status. Employer decision process 616 records approved selected plans, contribution rules, display settings, or scenario values as an approved spreadsheet scenario version 618. Propagation process 620 then updates booklet components, enrollment screens, election sheets, premium breakdown sheets, microsite components, carrier-notification records, customer relationship management renewal statuses, manifest records, and renewal dependency graph edges 622.

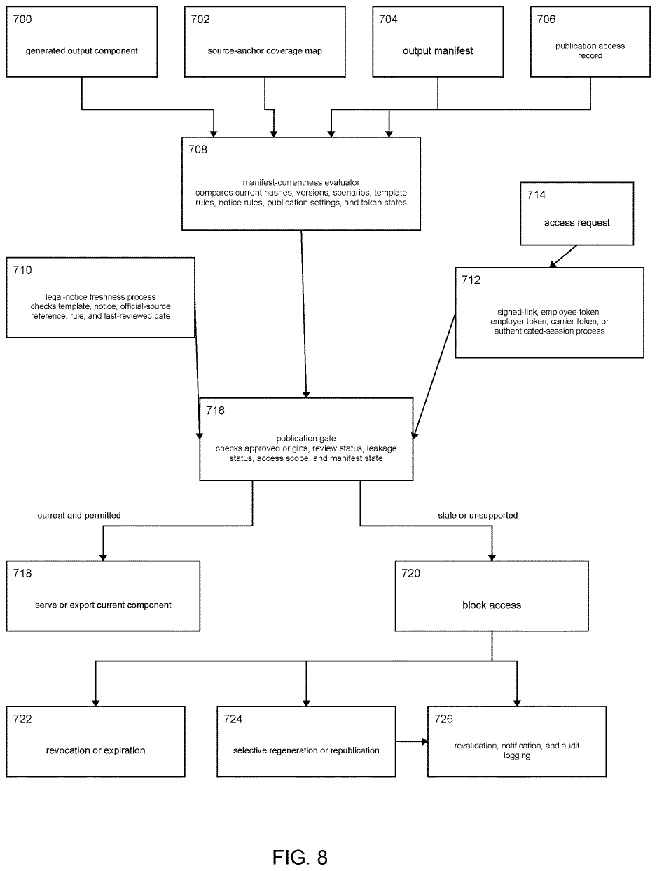

FIG. 8 illustrates an exemplary manifest-bound publication gate, source-anchor coverage-map evaluation, legal-notice freshness check, and access-control flow. A generated output component 700, source-anchor coverage map 702, output manifest 704, and publication access record 706 are associated with an output package, microsite component, enrollment screen, spreadsheet web view, request-for-proposal artifact, booklet page, compliance document, or linked artifact. A manifest-currentness evaluator 708 compares current source-document hashes, approved-record versions, source-anchor coverage-map versions, schema versions, template versions, rate-calculation rule versions, spreadsheet scenario versions, translation-rule-set versions, publication settings, and access-token states with values stored in the output manifest 704 and publication access record 706.

Referring still to FIG. 8, a legal-notice freshness process 710 can determine whether a compliance template, legal notice, official-source reference, plan-year applicability rule, or last-reviewed date is stale. A signed-link, employee-token, employer-token, carrier-token, or authenticated-session process 712 receives an access request 714 and passes the request to publication gate 716. The publication gate 716 serves or exports a current component at block 718 only when required values have source anchors or approved origins, no unresolved review or leakage condition remains, template and notice versions are current, access scope is permitted, and the manifest remains current. Otherwise, the publication gate 716 blocks access at block 720 and may trigger revocation, expiration, selective regeneration, republication, revalidation, notification, or audit logging at blocks 722, 724, and 726.

The retrieval-augmented extraction flow can operate at different granularities. In some embodiments, a single matched sample is selected for an entire Portable Document Format. In other embodiments, one matched sample is selected for medical benefits, another for prescription drug benefits, another for rates, and another for eligibility rules. In still other embodiments, the system retrieves multiple examples and votes among outputs, uses a model ensemble, or uses confidence-weighted field selection. The system may also select retrieval candidates based on carrier, plan type, state, product line, plan year, effective date, form identifier, or tenant-specific historical data.

The system can support explicit fallback rules. For example, if a target Portable Document Format does not state a carrier name but the upload context or filename identifies a carrier, the system may use the context only if a tenant policy permits fallback use and the field is marked as context-derived. If a value is absent, the system may leave the value blank, mark it missing, request user review, or use a tenant-approved template default. The source of each value may be stored so that target-derived, context-derived, user-entered, template-derived, and computed fields can be distinguished.

The canonical schema may be maintained as a versioned schema. A plan structured data representation record may include a schema version, a plan type, field identifiers, display labels, values, normalized values, units, source anchors, confidence, reviewer status, user comments, and effective dates. When the schema changes, the platform may migrate records, retain legacy fields, or maintain compatibility layers for older generated outputs.

A plan library may store approved plans for reuse. Users can load a plan into a new booklet, copy a prior plan, copy an entire booklet, apply year-over-year changes, update a carrier document, or compare extracted values against the prior-year plan. A correction made by a user can be used to update the plan library and, where permitted, to improve extraction for similar documents.

The renderer, Portable Document Format generator, and merger 120 can generate document components from templates and canonical data. A template may be a Hypertext Markup Language template, a database-stored template, a Blade or other server-side template, a client-side template, a document fragment, a Portable Document Format template, a spreadsheet template, or another output definition. The renderer can populate templates with company data, plan data, benefit fields, legal notice fields, rate outputs, logo assets, theme values, and page-order metadata. Generated components can be converted to Portable Document Format and merged with uploaded Portable Document Format documents in the selected order.

The platform can maintain an ordered component list for a booklet. The ordered list can include generated cover, table of contents, plan pages, comparison pages, definitions, notes, legal notices, compliance documents, uploaded Portable Document Format attachments, back cover, and other pages. When a user drags and drops components, the ordered list changes and the system recalculates table of contents entries, page numbers, section headings, and merge order. The final output can be a Portable Document Format, editable Portable Document Format, flipbook, downloadable link, printable booklet, microsite content, quick-response-code link, or package of multiple documents.

A translation module can translate a generated booklet or selected sections into Spanish or another language. Translation may be performed by a separate translation service, a local model, a domain dictionary, a human review workflow, or a hybrid method. For example, translation software can be listed on another server and we have each piece of text sent to the server via an API and returned as Spanish in order to keep from users facing formatting issues on their booklet. Simply sending a document; PDF, Word, etc. to a translation software results in really bad formatting errors, and the present invention does not have these issues since it is set up to translate the text along and then repopulate a new document in those sections. In some embodiments, the platform sends plain text extracted from the generated booklet to a translation server, receives translated text, formats the translated text into a translated booklet, saves the translated output, and emails or otherwise transmits a link to the user. The system may preserve field identifiers so that a reviewer can identify which original fields produced translated text.

The compliance and legal document module 122 can generate compliance documents and notices with minimal redundant data entry. For example, company name, tax identifier, address, plan year, plan names, plan provisions, contacts, email addresses, carrier names, and agency contacts may be populated from the company and plan records to eliminate the typical duplicate manual data entry all users face when not using a system like this. A user may select an annual notice or compliance document in Step 2 and later download, preview, edit, translate, or publish it. The system can create a wrap summary plan description, premium-only-plan document, broker compensation disclosure, premium-only plan, carrier termination letter, or other compliance artifact based on a template and canonical fields.

The premium and payroll deduction engine 118 can compute values used in election sheets and premium breakdown sheets. The engine can accept monthly premium values, employee premium values, employer contribution values, contribution percentages, fixed-dollar contributions, number of pay periods, premium frequency, deduction frequency, rate type, tier, age, class, employee attributes, and selected coverages. The engine can output employee per-paycheck deduction amounts, employer monthly contribution, employer annual contribution, employee monthly amount, total premium, and formatted values. The outputs can populate booklet pages, election sheets, spreadsheets, enrollment screens, and customer relationship management records.

The election sheet generator can produce a paper or electronic election sheet. The sheet can list company information, employee information, plan names, rate options, check boxes or selection controls, per-paycheck deductions, employer contributions, waiver options, dependent information, signature lines, date fields, required disclosures, and carrier enrollment instructions. The election sheet can be generated without re-entering plan data because the fields are derived from the canonical benefit data and rate engine outputs.

The premium breakdown generator can produce a dynamic sheet summarizing premiums, employer contributions, employee deductions, tier selections, and total costs. The sheet can be generated at the end of booklet creation or on demand. Because it is derived from stored plan and rate data, it can remain consistent with the booklet, election sheet, enrollment site, and spreadsheet exports.

The microsite and enrollment site module 126 can generate a hosted company-specific microsite. The microsite may display selected benefit booklet sections, videos, frequently asked question pages, carrier links, downloadable documents, quick response code landing pages, contact information, enrollment deadlines, plan comparison pages, premium data, and links to enrollment forms. The microsite may be public, unlisted, password-protected, employee-specific, role-protected, or gated by a login or unique token. Access events can be logged.

An enrollment workflow can allow employees or eligible participants to review plans, enter family or dependent data, compare plan options, select or waive coverages, confirm contributions, upload dependent documentation, sign disclosures, and submit elections. The workflow can store enrollment state in the customer relationship management module and can generate confirmation receipts, election sheets, administrative reports, and carrier files. An employer administrator or agent can track completion status, missing information, waiver status, and submission history.

The customer relationship management module can integrate with the enrollment workflow and booklet workflow. Company records can contain booklets, microsites, enrollment sites, request-for-proposal projects, contacts, agents, employees, tasks, notes, documents, payment records, subscriptions, and generated output links. The customer relationship management module can expose dashboards, filters, reminders, renewal statuses, open enrollment deadlines, and permissioned views for agents, agencies, employers, or administrators.

The request-for-proposal and spreadsheet automation module 124 can create request-for-proposal packages for carrier or vendor marketing. A user may select lines of coverage, target carriers, census information, plan information, employer preferences, current coverage, required questions, due dates, attachments, and desired outputs. The platform can generate spreadsheets, questionnaires, Portable Document Format documents, emails, package links, and tracking records. Carrier responses can be imported, normalized, compared, and stored with the company and plan records.

Spreadsheet automation can include import and export of company lists, census files, plan data, rate grids, request-for-proposal responses, premium breakdowns, renewal reports, and self-funded reporting templates. Imported spreadsheets can be validated for required columns, row counts, data types, invalid values, duplicate records, mismatched coverage classes, and inconsistent rate tiers. Validated rows can batch-create companies, employees, plans, rates, or request-for-proposal records. Exported spreadsheets can include formulas, formatted tables, hidden metadata, source references, and audit identifiers.

The platform can support payment and subscription functions. A payment processor may handle subscription billing, transaction payment, printing payment, setup fees, add-on modules, usage metering, or other financial transactions. The subscription state can control access to features, number of companies, number of booklets, number of generated documents, enrollment capacity, request-for-proposal capacity, storage limits, or machine-learning extraction usage. Payment records can be associated with tenant records and audit logs.

The platform may include tutorial, support, and training modules. Video tutorials can be grouped by step or function. A main video may play a complete workflow, and sub-videos may explain specific portions such as overview, entering plan data, bulk and triple options, plan library, Portable Document Format library, rates, disability and supplemental benefits, self-funded reporting, enrollment setup, request-for-proposal setup, and security setup. Tutorial records can be updated without changing core workflow code.

The platform can generate a “copy booklet” or renewal workflow. A user can copy a prior-year booklet, update company data, update rates, upload new carrier documents, run the source-anchored sample-retrieval and target-source-only extraction process against changed plan documents, compare extracted values to prior-year values, confirm changes, and generate a new-year booklet and enrollment site. The copy workflow can save time and preserve consistency across years while allowing small changes to be made quickly.

The platform may include speech-to-text entry. A user can click a microphone control and dictate field values, notes, descriptions, plan explanations, or custom sections. Speech output can be transcribed into an input box, validated, stored, and used in generated outputs. The system may identify dictated commands such as adding a row, moving to the next field, saving a plan, or previewing a page.

The platform can maintain audit events. An audit event may record actor, tenant, company, plan, document, field, action, timestamp, session, Internet Protocol address, request identifier, prior value, new value, source document hash, extraction run identifier, extraction-instruction version, model identifier, validation status, review status, generated output identifier, or publication link. Audit events can support troubleshooting, compliance review, security monitoring, and later reconstruction of a generated output.

Audit events and manifest records may be stored in an append-only log. Each event may include selected event contents, an event hash, and a hash of a prior event, prior batch, prior manifest state, source-document hash, generated-output hash, or approved-record version. The resulting audit chain can link authentication events, security-context creation events, source-object storage events, parser events, extraction-instruction events, model-invocation events, validation events, reviewer actions, approved-record versions, rendering events, publication events, access events, external-service transfer events, key-management events, revocation events, and generated-output hashes. The platform may compare stored hashes to detect missing, altered, reordered, or unauthorized audit entries.

Security controls may include transport layer security, role-based access control, tenant-specific document storage paths, tenant-scoped security contexts, signed worker capability tokens, object-store permissions, database access restrictions, encryption at rest, encryption in transit, envelope encryption, key-management or secrets-management services, user authentication, multi-factor authentication, step-up authentication, rate limiting, Internet Protocol logging, endpoint security, security information and event management forwarding, vulnerability scanning, backup, restore, disaster recovery, signed publication links, token revocation, data-egress policies, and tamper-evident audit logging. Administrative routes may be protected separately from user routes. External service calls may be logged and may omit, redact, tokenize, or minimize sensitive data according to tenant policy.

A key-management or secrets-management service may generate, wrap, rotate, disable, destroy, or provide access to encryption keys and integration secrets. Key identifiers and key versions may be stored with source-document records, approved normalized benefit records, generated-output records, enrollment records, and manifest records. Direct public access to object storage may be disabled, and object reads or writes may be permitted only through authenticated application-layer service principals, signed worker capability tokens, or short-lived signed links.

A secure deployment may use a virtual private cloud, firewall rules, separate application servers, separate database servers, object storage, load balancing, external monitoring, security information and event management collection, endpoint protection, and third-party security services. For example, user traffic may pass through an edge/load balancer into a cloud region, through a firewall boundary, to one or more web servers that communicate with one or more databases and an object store. Security telemetry can be transmitted to monitoring services. Such deployment is exemplary, and the platform can be deployed on other cloud, on-premises, hybrid, or managed hosting environments.

Backups can include database backups, document store snapshots, generated output archives, and configuration backups. Restore processes can restore a tenant, company, plan, document, output, or entire deployment. The platform may store backup metadata and perform periodic restore tests. Versioning can permit users to view prior versions of a plan, booklet, generated output, or source document.

The platform can support application programming interfaces. An application programming interface can allow retrieval, insertion, update, and deletion of entities such as companies, contacts, plans, documents, benefit fields, rates, booklets, compliance documents, enrollment records, request-for-proposal records, generated outputs, manifests, and audit events. Application programming interfaces may use representational state transfer, graph-query-language interface, webhooks, file exchange, event streams, or other mechanisms. Application programming interface access may be permissioned by tenant, role, token, Open Authorization protocol credential, application programming interface key, certificate, service-principal credential, signed capability token, authentication assurance level, or other authentication method. Tokens may be short-lived, scoped to a company or operation, revocable, and logged with a session identifier or service-principal identifier.

In some embodiments, the user interface may display a side-by-side experience. One pane can show the target Portable Document Format or carrier document, a second pane can show extracted fields and confidence, and a third pane can show generated booklet preview or plan comparison. Selecting a field can scroll the target Portable Document Format to the source page or table. Editing the field can update both a canonical structured data record and a preview.

In some embodiments, the platform creates a field provenance record. A field provenance record can indicate whether the value came from an uploaded Portable Document Format, user entry, previous plan, sample library, spreadsheet import, customer relationship management import, carrier response, enrollment selection, template default, or computed formula. Field provenance can be rendered as an icon or tooltip in the user interface and stored in the audit log.

In some embodiments, the system calculates confidence and workflow routing. A field having a confidence value above a configured automatic-approval threshold may be approved without manual review, a field having a confidence value between configured review thresholds may be shown for review, and a field that is unsupported or has a confidence value below a configured blocking threshold may block generation until confirmed. Required fields may be enforced for certain output types. For example, an enrollment site may require certain eligibility fields and rates, whereas a preliminary booklet preview may permit missing rates.

Completeness rules can be evaluated before a generated output is released. For example, the platform can require that selected plan categories have required canonical fields, that a compliance document has required company and plan-year fields, that a premium breakdown has required rate and contribution inputs, that an enrollment page has required eligibility and waiver text, and that an extracted value has a target-source anchor unless a configured fallback rule identifies the user-entered or imported origin of the value. A release decision may be stored in the output manifest together with the rule results, reviewer approvals, and remaining exceptions.

In some embodiments, data quality rules operate across outputs. If a plan name is changed in the plan library, the platform can update booklet pages, election sheets, premium breakdowns, enrollment site labels, request-for-proposal spreadsheets, and customer relationship management plan records or can present a change-impact preview. If a rate value changes, the platform can identify generated outputs that may be stale and trigger regeneration.

In some embodiments, the platform supports digital publishing. A user may generate a Portable Document Format link, a quick response code, a flipbook link, a microsite link, an enrollment link, a request-for-proposal link, or a private download. The platform can store link metadata, access restrictions, expiration dates, password protection, employee-specific tokens, employer-specific tokens, role-protected session requirements, device restrictions, network restrictions, download counts, view counts, click counts, analytics, cryptographic signatures, token hashes, and revocation status. Published links may be revoked, regenerated, expired, disabled, or bound to a particular manifest or approved-record version.

Published outputs may be accessed through short-lived signed links, employee-specific tokens, employer-specific tokens, role-protected sessions, password-gated links, or tenant-scoped access grants. A signed link or access grant may include an output identifier, tenant identifier, company identifier, approved-record version identifier, manifest identifier, permitted action, expiration time, revocation status, optional employee identifier, optional device or network restriction, and cryptographic signature or token hash. Before serving a booklet, microsite, enrollment page, flipbook, spreadsheet, election sheet, compliance document, request-for-proposal artifact, or download package, the publication service may verify that the link or access token has not expired or been revoked and that the referenced manifest remains current.

If a source-document hash, approved-record version, schema version, template version, rate-calculation parameter, translation-rule-set version, publication setting, employee eligibility state, or reviewer approval changes, the publication service may invalidate, revoke, expire, block, or require regeneration of affected links based on manifest records. A user may be shown a stale-output warning or may be required to approve a new version before publication resumes.

In some embodiments, the platform supports printing. A generated booklet can be prepared with page size, bleed, saddle-stitch options, cover options, paper selections, shipping information, print quantity, and payment. The platform may route print-ready Portable Document Format documents to a print provider or provide downloadable print packages.

In some embodiments, the platform supports carrier login or carrier-facing workflows. A carrier user can access a request-for-proposal, submit quote data, upload plan summaries, provide rate grids, respond to questions, or approve plan representations. The platform can restrict carrier access to selected request-for-proposal projects or companies.

In some embodiments, the platform supports developer access. A developer may view logs, trigger parsers, inspect structured data representation, test application programming interfaces, manage templates, update extraction schemas, manage vector indexes, view system status, manage deployment settings, and view security events according to permissions.

In some embodiments, the platform can include machine-learning extraction beyond plan extraction. Machine-learning logic may generate custom explanations, summarize differences from prior-year plans, generate request-for-proposal questions, suggest missing legal notices, detect inconsistent rates, translate content, summarize enrollment trends, classify uploaded documents, route documents to the correct plan category, or recommend which pages to include based on selected benefits. Such machine-learning outputs may be reviewed, validated, and stored with provenance.

The platform can support fail-safe behavior. If machine-learning extraction is unavailable, the user may enter plan details manually, upload spreadsheets, load prior plans, or use templates. If a translation service is unavailable, the system may queue translation or allow generation of the English output. If a Portable Document Format merger fails, the system may retain generated components and identify the failed component.

The embodiments disclosed herein are not limited to insurance or health benefits. The same architecture can be used for retirement plan guides, executive benefit summaries, union benefit guides, government benefit packages, employee communications, compensation packages, educational benefit guides, compliance document packages, vendor comparison packages, or other benefit-related document and workflow automation.

The disclosed system can be implemented using database transactions, job queues, message queues, worker processes, event-driven architecture, or synchronous requests. Long-running tasks such as Portable Document Format parsing, machine-learning extraction, Portable Document Format generation, translation, request-for-proposal package creation, and spreadsheet import may be handled asynchronously and reported to users through status updates, notifications, progress bars, webhooks, or dashboards.

In some embodiments, a generation event includes a snapshot. The snapshot can record the exact plan data, company data, rate data, template version, document version, theme version, and output settings used to generate a booklet or other output. A later edit does not change the historical snapshot unless the output is regenerated. The snapshot can support auditability and reproducibility.

In some embodiments, the platform can compare two booklets, two plans, two extraction results, two rate grids, or two versions of a document. A comparison engine can highlight changed fields, added plans, removed plans, rate changes, contribution changes, changed legal notice selections, changed documents, and changed templates. The comparison can be shown before renewal publication.

In some embodiments, the platform can apply tenant-level branding. Branding can include agency logo, default color palette, preferred cover pages, default back cover, phone numbers, Uniform Resource Locators, quick response codes, disclaimers, default notices, footers, and print settings. The branding can be overridden per company or per booklet if permitted.

In some embodiments, the platform can apply rules for page inclusion. For example, if a health-savings-account-compatible medical plan is selected, the system may recommend or automatically include a health savings account page. If the Consolidated Omnibus Budget Reconciliation Act applies, a Consolidated Omnibus Budget Reconciliation Act notice may be selected. If Medicare creditable coverage is indicated, a Medicare Part D notice may be included. If Spanish translation is selected, the system may generate translated versions of selected outputs. Rule recommendations may be reviewable and not mandatory.

In some embodiments, the platform can create benefit comparisons. A comparison page may display multiple plans side by side, with rows derived from canonical benefit fields. If plans differ in field availability, the system may align common fields, flag missing values, or use template-specific display rules. The comparison can be used in booklets, microsites, enrollment sites, request-for-proposal packages, or spreadsheets.

In some embodiments, the platform can use a document classification step before extraction. A classifier may determine whether an uploaded document is a summary of benefits and coverage, benefit summary, rate sheet, certificate, enrollment form, legal notice, carrier contract, census spreadsheet, request-for-proposal response, or other document type. The classification result can route the document to the appropriate parser, schema, or review screen.

In some embodiments, the parser can extract tables with page and column structure. A table row may be mapped to a canonical field using row label, column heading, plan type, matched sample, language model output, and validation rules. If an out-of-network value appears in a column, the validator can store it separately from an in-network value. If a field is shown as “not covered,” “none,” “not applicable,” “N/A,” “waived,” “100%,” “after deductible,” or similar text, normalization rules can preserve display text while storing a canonical value.

In some embodiments, the platform can produce structured data exports. Exports can include canonical structured data, comma-separated values, Excel, application programming interface payloads, carrier files, enrollment files, and request-for-proposal comparison files. Exports may include source anchors and confidence values so that downstream systems can determine whether a field was user-confirmed, machine-learning-extracted, or computed.

In some embodiments, employee enrollment selections can feed back into the premium engine. After an employee selects coverage tiers and dependents, the system can compute employee deductions and employer contribution impact. The employer administrator can view aggregate enrollment, plan participation, pending waivers, and incomplete elections. The system can generate carrier submission files or reports.

In some embodiments, the request-for-proposal module can reuse extraction and schema logic. Carrier quote responses can be parsed, mapped to the same canonical plan schema, validated against uploaded quote documents, compared to incumbent plans, and rendered into a proposal booklet or comparison spreadsheet. This reuses the extraction, validation, and rendering infrastructure developed for booklet generation.

In some embodiments, the platform can integrate with external customer relationship management systems, human-resources information system platforms, payroll systems, enrollment platforms, carrier systems, document-signature systems, email marketing systems, analytics systems, payment systems, and translation systems. Integration may be one-way or two-way and may include mapping rules, webhooks, scheduled synchronization, and error handling.

In some embodiments, privacy controls can limit data sent to external machine-learning services and other external services. The system may redact employee identifiers, remove dependent data, truncate documents, send only plan summary text, use tenant-approved model endpoints, require an administrator approval before external processing, or apply a tenant-specific data-egress policy before transmitting source text, source segments, employee data, dependent data, enrollment data, census data, rate data, payment data, generated output data, or audit data to an external parsing service, language-model service, translation service, email service, payroll service, carrier service, payment service, analytics service, monitoring service, or other integration. The system may record which data was sent to which service and when.

A tenant-specific data-egress policy may identify approved endpoints, permitted data classes, redaction rules, tokenization rules, field-minimization rules, retention settings, model-use restrictions, sample-library restrictions, geographic restrictions, logging requirements, and tenant-consent requirements. The platform may redact or tokenize employee names, dependent names, dates of birth, Social Security numbers, member identifiers, addresses, payment data, salary data, medical-condition fields, or other fields not required for the external operation.

The platform may store a data-transfer audit event identifying the tenant, user or service principal, security context, destination service, endpoint category, data class, policy version, source-object identifier, approved-record version, manifest identifier where applicable, time of transmission, data-minimization method, redaction method, tokenization method, and retention setting applied.

In some embodiments, tenant administrators can configure machine-learning extraction policies. Policies can specify whether machine-learning extraction is enabled, which model endpoints may be used, whether approved target documents may enter the sample library, whether samples are tenant-only or global, what confidence threshold triggers review, and what fields require manual confirmation regardless of confidence.

In some embodiments, the platform can store extraction-instruction versions and extraction run metadata. Metadata can include extraction-instruction template identifier, extraction-instruction version, schema version, matched sample identifier, similarity score, model identifier, model temperature or decoding settings, parser version, extraction time, validation status, reviewer identity, and approval time. This metadata can support reproducibility and continuous improvement.

In some embodiments, the platform can improve the sample library after human review. If a user corrects a field, the correction can be associated with source anchors. A supervisor may approve addition of the corrected target document to a tenant-specific library. The embedding index can then include the target document as a new example for future retrieval. The system can prevent sensitive employer-specific or employee-specific data from entering a shared library unless policy permits.

In some embodiments, the platform can use active learning. The system may identify repeated corrections for a carrier or plan type and create a new rule, extraction instruction, schema mapping, or validation rule. The system may notify an administrator when extraction performance for a carrier is poor or when a new sample would improve retrieval coverage.

In some embodiments, the system can display analytical dashboards. Dashboards can show number of companies, booklets, active enrollments, pending request-for-proposal workflows, generated documents, machine-learning extraction success rates, average review time, missing fields, most frequently corrected fields, storage usage, payment status, and security events. Dashboards may be role-restricted.

In some embodiments, the platform can support multi-language output beyond Spanish. A translation workflow may use a controlled term list and translation rules for insurance terms, carrier names, plan names, legal terms, and benefit-specific phrases. Translated outputs may be generated after a source output is approved and may be marked as requiring human review for legal or compliance language.

In some embodiments, the platform can maintain disclaimers and approvals. A tenant may require approval before publishing a booklet, enrollment site, microsite, or request-for-proposal response. Approval records can include approver identity, timestamp, version, comments, and conditions. The system may prevent changes after approval unless a new version is created.

In some embodiments, the platform can support white-labeling. Agencies, general agencies, brokers, or enterprise users can display their own branding on login pages, booklets, microsites, enrollment sites, emails, and generated documents. Administrative users may configure which fields are visible to sub-users and which outputs can display tenant branding.

In some embodiments, the platform can support printing and shipping workflows. A generated booklet can be submitted for printing, saddle stitching, shipping, or fulfillment. The system may store quantity, shipping address, shipping cost, tracking information, and payment status.

In some embodiments, the system can produce administrative and security artifacts generated from operational platform records. These artifacts can include environment configuration records, deployment configuration records, backup-policy records, security diagrams, vulnerability-scan records, data-flow diagrams, role-permission matrices, audit-log exports, incident records, and access-review reports. Such artifacts may be linked to tenant identifiers, environment identifiers, time periods, user roles, source-object versions, output-manifest versions, or security-event identifiers so that administrative users can verify configuration state and access posture without changing generated benefit outputs.

In some embodiments, the platform can maintain feature flags. Feature flags can enable machine-learning extraction, request-for-proposal module, enrollment module, spreadsheet automation, translation, payment processing, carrier login, developer login, or new template types for selected tenants or roles. Feature flag changes can be logged.

In some embodiments, the platform can be used with manual document creation. A user may skip machine-learning extraction and manually enter data, upload completed Portable Document Format documents, or build a booklet from external Portable Document Format documents. The same rendering, merging, publication, translation, and audit systems can still be used.

In some embodiments, plan and document data may be stored with object keys and relational metadata. The object store may store the binary Portable Document Format, images, generated Portable Document Format documents, spreadsheet files, and exported packages. The relational database may store metadata and links. This separation can improve storage scalability and access control.

In some embodiments, the system may process multiple uploaded Portable Document Format documents concurrently. A job queue can parse each Portable Document Format, create embeddings, retrieve samples, invoke models, validate outputs, and notify the user. A batch extraction screen can display status for each document and allow approval in sequence or in bulk.

In some embodiments, the platform can detect duplicate documents or duplicate plans. The system may compare hashes, filenames, text similarity, plan names, effective dates, carrier names, or embedding similarity. Duplicate detection can prevent redundant uploads and reduce sample library noise.

In some embodiments, the platform can create and maintain a “must-review” queue. Fields with missing evidence, low confidence, changed values relative to prior year, unusual rate values, inconsistent tier counts, changed carrier names, or conflicting source documents can be routed to a user. A review queue can prioritize high-risk fields, such as deductible, out-of-pocket maximum, premium, employer contribution, eligibility, or compliance date.

In some embodiments, the system can generate an output manifest. The manifest can list each component of a booklet or output package, the component type, source template, source data version, source document version, generated file hash, page count, and merge order. The manifest can be stored with the generated output and can be used for verification.

In some embodiments, the system can support post-generation edits. A user may edit a generated Portable Document Format, create an editable Portable Document Format, or make changes outside the system. If an externally edited Portable Document Format is uploaded back to the platform, the system can store it as an edited output and distinguish it from system-generated outputs. The system may warn that externally edited outputs may not reflect canonical data.

In some embodiments, the platform can use rule-based and machine-learning-based consistency checks. For example, the system may detect when a plan is labeled as health-savings-account-compatible but shows a first-dollar office visit copay, when an out-of-pocket maximum is lower than a deductible, when an employee deduction exceeds total premium, when a contribution type is incompatible with a rate type, or when a legal notice selection conflicts with plan selections. The system may flag issues rather than automatically changing values.

In some embodiments, the platform can update table of contents and page numbering automatically. If a user adds, deletes, or reorders pages, the system recalculates page counts and table entries. Uploaded Portable Document Format documents can be counted as components, and generated sections can include page numbers adjusted to the final merge order.

In some embodiments, the platform can support nested tenants and agencies. An enterprise tenant can have multiple agencies, each agency can have agents, and each agent can have companies. Permissions can determine whether plan libraries, document libraries, templates, and sample libraries are shared across the enterprise, across an agency, or restricted to a user.

In some embodiments, the system can generate notifications. Notifications may be sent when extraction completes, review is required, a booklet is generated, an enrollment deadline approaches, an employee submits an election, a carrier submits a request-for-proposal response, a payment fails, a publication link is accessed, or a security event occurs. Notifications may be email, text-message, dashboard, webhook, or in-app messages.

In some embodiments, the platform can support time-bound and status-bound publication. A microsite or enrollment site can open on a specified date, close on a specified deadline, display different content before and after enrollment, or require approval before going live. The platform can automatically revoke or archive links after a plan year.

In some embodiments, the system can support separate development, staging, and production environments. The environments may have separate databases, object stores, secrets, logs, and access controls. Deployment pipelines may run tests, migrations, and security checks before production deployment.

In some embodiments, the system can provide an application programming interface for downstream printing, enrollment, human-resources information system, or carrier systems. The application programming interface can deliver generated Portable Document Format links, election results, plan fields, rate grids, employee elections, audit events, or request-for-proposal responses. A webhook can notify external systems when an output is generated, approved, published, revoked, or updated.

In an exemplary operation, a broker logs in, selects a company, creates a new booklet, chooses a cover style, selects medical, dental, vision, life, and disability plans, selects annual notices and a broker compensation disclosure, uploads carrier summary of benefits and coverage Portable Document Format documents, and starts extraction. The platform parses the Portable Document Format documents, retrieves similar samples, generates structured benefit data representation, validates values, and displays a review screen. The broker corrects two fields, approves the plan, uploads rate data, and generates a booklet, election sheet, premium breakdown, Spanish translation, microsite, and enrollment link.

In another exemplary operation, an agency copies a prior-year booklet. The platform loads prior company data, prior plan selections, prior pages, prior uploaded Portable Document Format documents, and prior rate grids. The agency uploads new-year summary of benefits and coverage documents and rate sheets. The source-anchored sample-retrieval and target-source-only extraction engine extracts new values from the new-year target source documents, and the comparison engine highlights changed deductibles, out-of-pocket maximums, and rate values. The agency confirms the changes, regenerates the booklet, and publishes a new quick-response-code microsite.

In another exemplary operation, a user starts a request-for-proposal for a client. The platform imports a census spreadsheet, selects requested coverages, attaches incumbent plans from the plan library, generates carrier questionnaires, sends package links, tracks responses, parses quote documents into the canonical schema, compares carrier responses, and generates a proposal booklet and spreadsheet comparison. The resulting selected plan can be moved into the booklet and enrollment workflow without re-entry.

In another exemplary operation, an employer administrator opens an enrollment dashboard. The administrator sees employees who have not completed elections, employees with missing dependent documentation, employees who waived coverage, and aggregate plan participation. The platform generates confirmation receipts and exports carrier files. The benefit booklet, rate calculations, election forms, and enrollment pages are all derived from the same canonical benefit and rate data.

Although the disclosure includes examples involving employee benefit booklets and compliance documents, the systems and methods can be applied to any workflow in which heterogeneous source documents must be transformed into structured benefit, plan, compliance, or enrollment data and then used to generate multiple related outputs.

### Additional Embodiments

The following embodiments provide additional support for the model-assisted, source-anchored, multi-output, and security-aware features described above. These embodiments may be combined with any booklet, compliance-document, microsite, request-for-proposal, spreadsheet, customer relationship management, enrollment, translation, payment, or security embodiment described in this specification.

In some embodiments, each uploaded or imported benefit source document is stored as a source object. The source object may include a source-object identifier, tenant identifier, company identifier, plan identifier, file hash, storage key, original filename, upload timestamp, uploader identity, parser version, source-document type, carrier name, effective date, plan year, page count, and one or more extracted text representations.

A parser can divide the source object into source segments. A source segment can include a page span, a line span, a table region, a table row, a table cell, a bounding region, a heading, a footnote, a rate row, a benefit-field label, or a value candidate. The parser may store source segments with offsets, page numbers, coordinates, confidence values, and relationships to neighboring segments so that later generated fields can be traced back to the document portions from which they were derived.

In some embodiments, the extraction engine generates one or more embeddings, namely numerical vector representations, from the target document or target source segments. The numerical vector representations may represent the full document, selected chunks, tables, carrier identifiers, plan labels, effective dates, rate tiers, deductible terms, copayment fields, coinsurance fields, out-of-network fields, plan-year metadata, or any combination thereof.

A vector retrieval module can search a sample repository containing previously processed benefit source documents, extracted text, structured data representation, canonical benefit records, user-corrected fields, and output histories. The retrieval module may select one or more matched samples using semantic similarity, carrier similarity, plan-type similarity, effective-date similarity, schema compatibility, tenant permission, document-type classification, historical correction rate, or combinations thereof.

In some embodiments, the matched sample is used as a structural reference without using the matched sample as the source of values for the target document. An extraction instruction builder can create an extraction request containing target source text, target source segments, the matched sample text, matched sample structured data, a canonical schema, field definitions, normalization rules, and instructions requiring extracted values to be supported by the target document unless an expressly configured fallback is permitted.

A language model, extraction model, rules engine, or hybrid engine can generate candidate structured benefit data. The candidate data may be formatted as structured data representation or another structured format and may include fields such as carrier name, plan name, plan type, deductible, out-of-pocket maximum, copayment, coinsurance, inpatient benefit, outpatient benefit, prescription benefit, rate tier, eligibility rule, contribution rule, payroll deduction amount, legal notice applicability, or plan-year metadata.

A schema validation and source-anchoring module can compare each candidate field against a canonical schema and against target source segments. The module may normalize currency, percentage, tier, date, carrier, plan-name, and network labels; detect missing fields; detect values that are inconsistent with surrounding source text; determine whether a field has source support; assign a field confidence; and store an evidence anchor identifying the page, table, row, cell, line, coordinate, or text span that supports the field.

In some embodiments, the schema validation and source-anchoring module creates a source-anchor coverage map before output generation or publication. The coverage map may include a record for each required field or output component and may store field identifier, output-component identifier, source-anchor identifier, origin type, confidence value, review status, rule identifier, blocking status, last-validation timestamp, and last source-document hash. The map may distinguish target-source-derived values from user-entered values, imported values, computed values, template-derived values, and missing values.

In some embodiments, the schema validation and source-anchoring module detects sample leakage by comparing candidate values with matched-sample values, prior-year values, and target source segments. A candidate field may be blocked or routed to review when the candidate field is supported by a matched sample or prior-year record but not by the target source object, when a target-source search fails to locate the normalized candidate value or equivalent display text, or when surrounding target text contradicts the candidate value.

The system may route unsupported, missing, anomalous, or below-threshold-confidence fields to a must-review queue. A review interface can display the candidate field, the matched sample context, the target source segment, surrounding text, prior-year values, tenant rules, and suggested normalized values. A reviewer may approve, correct, reject, merge, split, or annotate the field, and the resulting decision may be stored with reviewer identity, time stamp, source anchor, and reason metadata.

After review or automatic validation, the system can create or update a canonical benefit record. The canonical benefit record may include structured benefit data representation, relational fields, document references, source anchors, plan versions, effective dates, tenant permissions, source-document hashes, review status, approval status, and audit events. The canonical benefit record may be used as a single source of truth for multiple downstream modules.

In some embodiments, the canonical benefit record is shared by a booklet generator, a legal-notice generator, a wrap summary plan description generator, a premium-only-plan document generator, a broker compensation disclosure generator, a request-for-proposal generator, a spreadsheet automation module, a customer relationship management module, an enrollment site module, a microsite module, a translation module, a rate and payroll deduction engine, a quick-response-code link service, a flipbook service, and a publication service.

The system can generate an output manifest for each generated artifact or artifact package. The manifest may identify source objects, source hashes, canonical-record versions, template versions, extraction-instruction versions, schema versions, parser versions, model identifiers, user approvals, rendering engine versions, output hashes, publication links, expiration dates, access permissions, and generated pages or sections. The manifest can be stored with the output and used to reproduce, audit, correct, or invalidate the output.

In some embodiments, a prior-year booklet or plan is copied, and the system compares the copied canonical benefit record to newly extracted values from current-year documents. Differences may be routed to review based on configured thresholds, including changes in deductible, out-of-pocket maximum, copayment, network status, contribution amount, plan name, carrier name, rate guarantee, or legal-notice applicability.

The compliance module may include jurisdiction, plan-type, date, employer-size, carrier, and tenant rules for selecting annual notices, legal notices, wrap summary plan description fields, premium-only-plan document fields, broker compensation disclosure fields, and related compliance documents. The system may merge company data, plan data, contact data, document metadata, and tenant-specific text into compliance templates and may record which rules caused a document or notice to be selected.

The rate and payroll deduction engine may calculate employee deductions or employer contributions using one or more rate tables, contribution formulas, pay-period counts, rate-tier types, composite rates, age-banded rates, four-tier rates, three-tier rates, two-tier rates, Affordable Care Act rates, life-rate factors, disability-rate factors, accident-rate factors, critical-illness-rate factors, employee-only premiums, employee-plus-spouse premiums, employee-plus-children premiums, family premiums, fixed-dollar contributions, percentage contributions, and employer/employee allocation rules.

The enrollment site module may generate employee-facing workflows using the approved canonical benefit record. The workflows may display plan options, costs per pay period, eligibility rules, dependent fields, waiver options, election confirmation pages, acknowledgments, notices, and deadlines. The enrollment site may write election records back to the canonical data store and may update customer relationship management status, employer dashboards, payroll export files, and employee election sheets.

The request-for-proposal and spreadsheet automation modules may use the canonical benefit record to generate proposal packages, request templates, plan comparison spreadsheets, rate grids, census imports, renewal summaries, quote analysis, and carrier-facing or employer-facing reports. The system may import spreadsheet data, normalize rows and columns, map spreadsheet values to canonical fields, and export populated spreadsheets or document packages.

The system may operate in a multi-tenant security architecture. The architecture may include role-based access control, tenant isolation, tenant-scoped security contexts, signed worker capability tokens, encrypted object storage, envelope encryption, key-management services, database access controls, secret storage, audit logs, append-only or hash-linked audit chains, firewall rules, load balancing, virtual private cloud boundaries, endpoint monitoring, security telemetry, backup and restore records, anomaly reporting, data-egress policies, and signed or tokenized publication access. Generated links may be time-limited, permission-limited, tokenized, bound to a manifest, or disabled when an output is superseded.

The multi-tenant security architecture may bind each source object, extraction job, review action, output generation request, publication action, employee enrollment session, application programming interface request, and external-service call to a tenant-scoped security context. This binding permits the platform to prevent cross-tenant access to source documents, sample-library entries, approved normalized benefit records, output manifests, enrollment records, generated artifacts, and publication links.

In some embodiments, background jobs process multiple source documents concurrently. A queue can assign parsing, embedding, retrieval, model invocation, validation, review notification, rendering, merging, translation, publication, and audit tasks. Job state may include queued, processing, review required, approved, failed, superseded, published, expired, or archived states.

The system may detect duplicate or conflicting documents using file hashes, text similarity, plan-name similarity, carrier similarity, effective-date comparison, vector similarity, or output history. Duplicate detection may avoid redundant model invocations, reduce inconsistent plan records, and route conflicting documents to review before downstream outputs are generated.

In some embodiments, translation uses a controlled-term workflow. Insurance terms, plan names, carrier names, compliance terms, and tenant-specific phrases may be preserved, translated, reviewed, or substituted according to tenant-selected translation rules. The translated output may retain source anchors, output manifest references, and links to the original approved canonical record.

Human-approved corrections may be added to a sample library after permission and quality checks. The system may store the corrected target text, structured data, source anchors, schema version, and approval metadata as a new sample or as a revised sample. Later target documents may retrieve the corrected sample, thereby improving future extraction consistency while preserving tenant permissions and preventing unauthorized cross-tenant disclosure.

The disclosed retrieval-augmented extraction, extraction, validation, review, rendering, and publication operations are not limited to a particular model, vector index, parser, storage provider, programming language, framework, operating system, cloud provider, or application programming interface endpoint. For example, a vector search may use a vector similarity library, another approximate nearest neighbor index, a relational similarity search, a hybrid keyword/vector search, or a rules-based retrieval technique.

The disclosed embodiments provide technical improvements to computer operation for benefit-document generation. Examples include reducing duplicate entry of structured fields, reducing repeated parsing of identical Portable Document Format documents, maintaining versioned source-to-output traceability, automatically recalculating tables of contents and page numbering after page-order changes, validating model-generated fields against source anchors, limiting downstream publication to approved canonical records, and producing output manifests that allow generated artifacts to be reproduced or invalidated when source data changes. IMPLEMENTATION DETAILS

The following implementation details describe representative data records and operations by which the platform stores benefit source documents, converts those documents into source-addressable records, validates extracted benefit values, and generates final employee benefit outputs from approved data.

When a benefit source document is received, the platform creates a source-document data record containing file bytes or an object-storage key, a source-object identifier, tenant identifier, company identifier, plan-year identifier, document-type identifier, original filename, upload timestamp, uploader identifier, parser status, media type, language, page count, effective date, carrier identifier, line of coverage, and a cryptographic hash calculated from the received file bytes. The source-document data record may be stored in a relational database, and the corresponding file bytes may be stored in object storage under a tenant-specific key.

When a user, employee, invited reviewer, carrier user, developer, or service principal authenticates, the platform may create a security-context data record. The security-context data record may store tenant identifier, user identifier, role identifier, permitted company scope, permitted source-object scope, permitted sample-library scope, permitted output scope, permitted employee scope, authentication method, authentication assurance level, session identifier, issued-at time, expiration time, policy identifiers, revocation state, and device or network attributes. The platform may evaluate the security-context data record before permitting source upload, source parsing, matched-sample retrieval, extraction invocation, review approval, output rendering, publication, export, application programming interface access, or external-service transmission.

A background-job data record may include a signed work token or capability token. The token may identify a tenant, company, plan year, source-object identifier, source-document hash, approved-record version identifier, manifest identifier, operation type, output type, requesting user or service principal, queue name, job identifier, issued-at time, expiration time, and policy version. A worker can validate the token signature and compare stored source hashes, approved-record versions, manifest states, and revocation states before reading source-object bytes, invoking an extraction model, writing a generated output, transmitting data to an external service, or publishing a link.

A parser processes the stored source-document data record and creates segment records for addressable portions of the document. A segment record may identify a page, paragraph, line, table, table row, table cell, bounding region, heading, footnote, rate-tier row, network-benefit row, carrier-name region, plan-name region, text span, or image region. Each segment record may store page number, row identifier, column identifier, character offset, coordinate value, extracted text, optical-character-recognition confidence, table relationship, neighboring-segment relationship, parser version, and the cryptographic hash of the source document from which the segment was produced.

The parser or a downstream field-candidate generator may identify candidate field records from segment records. A candidate field record may include a schema field identifier, display label, raw value text, normalized value, value unit, plan type, network label, coverage tier, rate tier, contribution type, eligibility context, source segment identifier, candidate confidence, and reason why the value was selected. Candidate field records can be generated from table labels, column headings, row headings, nearby text, carrier-specific form labels, prior-year mappings, spreadsheet headers, or user-entered form values.

The platform may generate numerical vector representations from extracted text, table headings, row labels, document layout, carrier identifiers, plan identifiers, coverage-line identifiers, effective dates, and candidate fields. Each numerical vector representation can be associated with the source-document data record, a segment record, a table region, a field group, or an entire document. The numerical vector representations permit similarity searching without requiring a separate hand-coded parser for each carrier form layout.

A sample repository can store previously processed benefit documents, extracted text, structured field records, approved benefit records, source anchors, schema versions, reviewer correction history, permission metadata, quality scores, and vector representations. A retrieval process can compare a target numerical vector representation with stored vector representations and can also use carrier, plan type, coverage line, form layout, table heading, effective date, schema version, tenant permission, and reviewer-quality factors to select one or more matched samples for structural guidance.

An extraction instruction set can be assembled for a target benefit source document by combining target extracted text, target segment identifiers, target table structure, matched sample text, matched sample structured data, expected schema field identifiers, permitted data types, normalization rules, and extraction constraints. The extraction constraints can state that values for the target document must be supported by target source segments, that matched samples provide structure and field-mapping guidance rather than target values, that unsupported fields must be returned as missing or requiring review, and that non-missing fields should include source-page, table, row, column, coordinate, or text-span references when available.

The extraction instruction set may include one or more leakage-control instructions. A leakage-control instruction can require the extraction model to label each non-missing field with a proposed target-source location, prohibit use of matched-sample values as target values, identify values supplied from a user-entered or imported origin, and return an unsupported or review-required status when the target source object lacks a value that appears in a matched sample. The platform may store an extraction-instruction version so that a later manifest can identify which leakage-control instructions were used for a generated candidate field.

A retrieval operation may generate an embedding, meaning a numerical vector representation, from a target source object, a target source segment, a field label group, or a detected table region. A vector index may be searched to retrieve one or more candidate samples. The retrieval operation may score candidate samples using vector similarity, carrier similarity, coverage-line similarity, plan-year similarity, layout similarity, table-heading similarity, schema-version compatibility, reviewer-quality score, or any weighted combination of those features.

A validation routine compares each candidate field value with the target source segments. The validation routine can verify that a value is present in the source text or table structure, normalize currency and percentage values, normalize dates and plan-year values, map network labels, check carrier and plan identifiers, verify allowable schema enumerations, check rate-tier arithmetic, detect duplicated or conflicting documents, identify missing required fields, assign a confidence value, and determine whether a candidate value should be approved automatically or routed to review.

The validation routine may generate a target-evidence score by searching target source segments for an exact value, normalized value, synonym, display equivalent, table-position equivalent, or computed equivalent. The validation routine may generate a sample-leakage score by comparing the candidate value to one or more matched-sample values and prior-year values. A field can be marked leakage-suspected when the sample-leakage score exceeds a configured level and the target-evidence score is below a configured level.

For a supported field, the platform stores a source-anchor record linking the field to the source-document data record and to one or more source segments. A source-anchor record may include source-object identifier, source-document hash, page number, table identifier, row identifier, column identifier, coordinate region, character range, extracted text excerpt, parser version, schema field identifier, and validation status. The source-anchor record permits a generated value in a booklet, compliance document, enrollment page, spreadsheet, or request-for-proposal artifact to be traced back to the source text or table from which the value was taken.

A source-anchor coverage-map record may link a required field, generated page, output component, or publication element to one or more source-anchor records or to a permitted origin type. The coverage-map record may include output type, component identifier, schema field identifier, required-field rule identifier, origin type, source-anchor identifier, source-document hash, approved-record version, review state, blocking state, and exception reason. The publication service can query the coverage map before serving, exporting, or linking an output.

Candidate fields that lack source support, conflict with another source document, violate a schema rule, fail a rate-calculation rule, or fall below a configured confidence threshold can be routed to a review queue. The review queue may display the candidate field, proposed value, confidence value, target-source excerpt, source-anchor location, matched-sample context, schema field description, prior-year value, validation message, and actions including approve, edit, reject, mark not applicable, request more documents, map to another field, merge, split, or escalate. Reviewer actions can be stored with reviewer identity, timestamp, reason metadata, and before-and-after values.

After validation or review, the platform creates or updates an approved normalized benefit record. The approved normalized benefit record can store plan identity, carrier identity, coverage line, plan year, network values, deductible values, copayment values, coinsurance values, out-of-pocket maximum values, prescription values, eligibility rules, rate values, contribution rules, payroll-deduction settings, compliance selections, source anchors, confidence values, reviewer status, version identifier, tenant permissions, source-document hashes, and audit events. The approved normalized benefit record can be used as a single source of stored plan truth for multiple downstream output modules.

Output generation reads the approved normalized benefit record rather than re-reading unsupported extraction output. A renderer can populate templates with company fields, plan fields, benefit values, rate values, eligibility text, contact information, logos, cover selections, theme selections, page order, notice selections, and publication settings. Generated components can be converted to Portable Document Format documents, combined with uploaded Portable Document Format attachments, and ordered according to a component list that also stores page-number and table-of-contents data.

A rate and payroll-deduction engine can calculate employee and employer cost values from monthly premiums, employee premium values, employer contribution values, contribution percentages, fixed-dollar contribution values, number of pay periods, premium frequency, deduction frequency, rate type, rate tier, coverage class, employee attributes, dependent counts, life volume, disability volume, and selected coverages. Calculated values can populate benefit booklet tables, election sheets, premium breakdown sheets, enrollment pages, spreadsheets, and customer relationship management records.

A compliance-document process can select and populate annual notices, wrap summary plan description documents, premium-only-plan documents, broker compensation disclosures, carrier termination letters, and other compliance artifacts using company location, employer size, plan type, coverage line, plan year, selected benefits, carrier fields, plan provisions, contact fields, and template rules. Each populated field can retain a link to the approved normalized benefit record and to any source-anchor record or user-entered origin from which the field was derived.

An enrollment, microsite, and customer relationship management process can publish employee-facing plan options, eligibility information, cost-per-pay-period values, downloadable documents, quick response code links, microsite pages, enrollment pages, waiver options, dependent-entry fields, and election confirmations. Employee elections, dependent entries, waiver data, and completion status can be stored in enrollment records and customer relationship management records linked to the approved normalized benefit record and output manifest.

A request-for-proposal and spreadsheet process can import census files, rate grids, renewal information, proposal fields, carrier responses, employer contribution fields, and plan comparison fields. The process can export questionnaires, comparison spreadsheets, proposal packages, renewal reports, self-funded reporting templates, and carrier-facing or employer-facing reports using approved normalized benefit records, employee or census data, and source anchors.

For each generated output, the platform can create a manifest data record identifying generated file identifiers, output hashes, output type, source-object identifiers, source-document hashes, source-anchor identifiers, approved-record version identifiers, schema versions, template versions, page-order versions, rate-calculation parameters, translation-rule-set versions, extraction-instruction versions, parser versions, model identifiers, reviewer approvals, publication links, quick response codes, expiration dates, access permissions, timestamps, and user identifiers. The manifest may include a component-source map that identifies which source anchors, origin types, and coverage-map entries supplied each generated page, table, row, employee-facing value, employer-facing value, spreadsheet cell, request-for-proposal field, or enrollment-screen field.

For a published output, the platform may create a publication access record, signed link, employee token, employer token, access grant, or authenticated-session requirement. The publication access record may identify output identifier, tenant identifier, company identifier, employee identifier where applicable, approved-record version identifier, manifest identifier, permitted action, permitted audience, expiration time, revocation status, password requirement, device restriction, network restriction, cryptographic signature, token hash, created-by user, and last-access time. The publication service may resolve a quick response code, flipbook link, microsite link, enrollment link, or download link to a publication access record and may verify manifest currency, approved-record version, access scope, expiration, and revocation status before serving the output.

Audit events and manifest records may be written to an append-only ledger or log. A ledger entry may include event type, tenant identifier, user or service-principal identifier, session identifier, authentication assurance level, affected object identifier, source-document hash, approved-record version identifier, manifest identifier, generated-output hash, before-and-after values where applicable, timestamp, event hash, and prior-event hash. The platform may verify the event hash and prior-event hash to detect modification, deletion, insertion, or reordering of audit events or manifest records.

A publication gate can evaluate completeness rules, source-anchor coverage-map records, review-queue state, security context, publication-access records, and manifest currentness before an employee-facing or employer-facing output is released. The gate may block publication when a required benefit field lacks a source anchor or user-entered, imported, computed, or template-derived origin; when a required rate field has not been calculated; when a compliance document lacks required company or plan-year data; when an enrollment page lacks required eligibility or waiver text; when a field remains unresolved in the review queue; when a matched-sample leakage condition remains unresolved; when a signed link or access token is expired or revoked; or when a source-document hash, approved-record version, template version, schema version, rate-calculation parameter, translation-rule-set version, or publication setting differs from the state recorded in the manifest. If a change affects only selected output components, the platform may regenerate, revoke, expire, or revalidate only the affected components or links.

Before invoking an external parser, language model, translation service, payment service, email service, payroll system, carrier system, analytics service, monitoring service, or other external service, the platform may evaluate a tenant-specific data-egress policy. The policy may specify the approved endpoint, permitted data classes, permitted fields, redaction rules, tokenization rules, retention settings, model-use restrictions, sample-library restrictions, and consent requirements. The platform may remove, redact, tokenize, or withhold fields not permitted for the endpoint and may record a data-transfer audit event identifying the endpoint, policy version, data class, tenant, user or service principal, source object, approved-record version, and time of transmission.

After reviewer approval and permission checks, corrected target text, corrected structured data, source anchors, schema version, reviewer-quality indicator, permission metadata, and quality-control status can be stored in the sample repository. Later documents can retrieve the corrected representation as a matched sample while tenant-permission rules prevent unauthorized cross-tenant use of private source documents or private structured data.

The described operations can be implemented with one or more servers, processors, memories, databases, object-storage systems, job queues, worker processes, browser interfaces, application programming interfaces, parsing services, vector indexes, extraction models, rendering engines, translation services, logging services, monitoring services, and security services. A function described as being performed by a module, engine, controller, process, or service can be performed by executable instructions stored in non-transitory memory and executed by one or more processors, by dedicated hardware, by cloud services, or by any combination thereof. The scope of the invention is defined by the claims.

### Further Renewal Workflow Embodiments

The following embodiments further describe how the platform may be configured as an integrated renewal-workflow data engine for employee benefit agencies, brokers, consultants, employers, carrier-facing users, and related administrators. These embodiments connect the recurring operational workflow of a renewal project with the source-anchored extraction, canonical data, validation, security, manifest, and publication controls described above. The embodiments are illustrative and may be combined with any other embodiment described herein.

In some embodiments, a renewal project record is created for a company and plan year and includes one or more renewal phases. The renewal phases may include a request-for-proposal phase, a spreadsheet and proposal-comparison phase, a benefit-booklet phase, an annual-legal-notice phase, a compliance-document phase, a microsite phase, an enrollment phase, a carrier-notification phase, a client-approval phase, and a publication phase. Each phase may be represented by a phase-state record having a status, responsible user, due date, required inputs, selected outputs, source-document dependencies, canonical-record dependencies, review exceptions, publication permissions, and audit history.

The platform may maintain a renewal dependency graph linking source objects, carrier responses, census records, rate grids, plan-library records, employer contribution scenarios, canonical benefit records, generated pages, compliance templates, microsite folders, enrollment screens, publication links, and carrier or employer notifications. The renewal dependency graph can identify which downstream artifacts are affected by a changed deductible, changed rate table, changed employer contribution rule, changed legal notice template, changed carrier contact, changed census row, changed plan selection, changed translation rule, or changed publication setting.

In some embodiments, the same canonical benefit record is used to reduce repeated transformation of plan data across renewal phases. For example, plan fields extracted from a summary of benefits and coverage document or carrier summary may populate a comparison spreadsheet, a booklet plan page, an enrollment plan card, a microsite plan overview, an election sheet, a premium breakdown, a carrier-facing request-for-proposal artifact, and a compliance document. A correction made by a reviewer to the canonical benefit record may update the affected outputs according to the dependency graph rather than requiring separate manual edits in each output.

The platform may define required-field profiles for different output types. A preliminary renewal spreadsheet may require carrier name, plan name, coverage line, rate tiers, and selected high-level benefit fields, whereas an enrollment site may require eligibility rules, waiver text, employee cost values, dependent rules, and enrollment deadlines. A compliance document may require company name, plan year, plan administrator information, coverage-line information, and notice-specific rule inputs. The publication gate may evaluate the applicable required-field profile before permitting the output to be published, exported, linked, or served.

In some embodiments, the request-for-proposal module generates a carrier-facing dashboard rather than transmitting all source materials as ordinary email attachments. The platform may create one or more carrier invite records comprising a carrier identifier, carrier contact identifier, requested line of coverage, permitted document categories, due date, questionnaire fields, tokenized dashboard link, access expiration, revocation status, and audit state. The carrier-facing dashboard may present only the documents, census data, questionnaires, plan information, and source objects that correspond to the line of coverage or proposal request assigned to that carrier.

The carrier-facing dashboard may apply line-of-coverage segmentation. For example, a medical carrier may receive medical-plan source documents, census segments, current medical rates, and medical questionnaire fields, while an ancillary carrier may receive only dental, vision, life, disability, accident, or other ancillary coverage materials. The platform may enforce such segmentation through tenant-scoped security contexts, carrier-specific access grants, source-object access control lists, and manifest-linked publication records.

Carrier contact records may be stored and versioned at tenant, agency, enterprise, carrier, coverage-line, region, or company scope. When a carrier contact is updated, future carrier invite records may use the updated contact information without requiring users to re-enter email addresses for each request-for-proposal package. The platform may also allow users to save carrier-selection templates that include carrier groups, coverage lines, contact roles, default due dates, default questionnaire fields, and default access policies.

The request-for-proposal module may include completeness rules that prevent or warn against sending an incomplete package. Such rules may require company demographic fields, current coverage information, requested coverage lines, census file status, target effective date, quote due date, requested plan designs, required attachments, contribution assumptions, or prior-year plan references. When a field is missing, the platform may route the field to a user, mark the request as draft, or allow transmission only with an exception recorded in the manifest and audit log.

In some embodiments, a carrier user may upload a proposal, rate grid, plan summary, quote spreadsheet, or response document through the carrier-facing dashboard. The platform may store the submitted file as a source object, parse the submitted source object, map proposal values to the canonical benefit schema, validate the values against source anchors, and route unsupported or conflicting response values to review. Approved carrier response data may populate a proposal comparison, online spreadsheet, booklet, or enrollment workflow without requiring manual re-entry.

The platform may maintain request-for-proposal status events for sent, viewed, downloaded, in progress, submitted, returned for clarification, approved, declined, won, lost, or closed statuses. Status events may be displayed to agency users, authorized carrier contacts, carrier managers, employer users, or enterprise users according to role. The platform may trigger notifications when a carrier views a package, submits a quote, misses a due date, is selected as the winning carrier, or is not selected, and may store each notification event with the corresponding request-for-proposal manifest.

In some embodiments, the spreadsheet automation module generates a dynamic online spreadsheet or web view from approved normalized benefit records, carrier responses, rate grids, census data, employer contribution rules, and employer-specific display settings. The online spreadsheet may present plan options, rates, employer contribution scenarios, employee contribution values, renewal alternatives, carrier notes, source-anchor indicators, and client decision controls. The spreadsheet may be rendered as an interactive web artifact, exported spreadsheet, Portable Document Format document, or any combination thereof.

The dynamic spreadsheet may permit an employer or authorized client user to select which plans to offer, change contribution percentages or fixed-dollar contribution amounts, select contribution classes, hide or display plans, hide or display rows or columns, compare scenarios, and view resulting employee or employer cost impacts in real time. Each change may create a scenario record that stores the selected plans, contribution rules, rate table versions, census version, user identity, timestamp, and output state. An approved scenario may be promoted into the canonical benefit record or into an output-specific snapshot used for booklet, enrollment, premium-breakdown, and election-sheet generation.

In some embodiments, the platform uses a scenario engine to compute employer and employee cost impacts before final publication. The scenario engine may combine plan rates, census records, contribution formulas, rate tiers, class rules, employee attributes, dependent counts, payroll frequency, and selected coverage options to calculate monthly premiums, employer monthly amounts, employer annual amounts, employee monthly amounts, per-pay-period deductions, and aggregate renewal cost. Scenario outputs may be stored with source anchors and calculation-parameter identifiers so that a later reviewer can reproduce the calculation.

Authorized carrier users may be given limited access to portions of a spreadsheet or web view to enter or update carrier-owned plan details, rate values, proposal notes, or quote status. Carrier-entered values may be treated as imported origin values or source-object-derived values, may be hidden from employer users until agency approval, and may be validated against uploaded carrier response documents. Row-level, column-level, plan-level, or coverage-line-level permissions may determine which values a carrier may view or edit.

In some embodiments, a census processing module normalizes employee and dependent census data. A census record may include employee identifier, dependent identifier, relationship, date of birth, age, gender, tobacco status, address or rating area, employment class, salary, hours, eligibility date, coverage tier, waiver status, and other fields. The module may validate required columns, detect duplicate rows, group dependents by employee, map relationships to tier definitions, determine rating ages according to an effective date and carrier-specific age rule, and identify missing or anomalous census fields before rate calculations are performed.

For age-banded rates, the platform may match census participants to rate bands using date of birth, effective date, dependent status, rating-area information, class, tobacco status, child-count rules, adult-child rules, or carrier-specific rating rules. The platform may calculate per-employee, per-dependent, and aggregate premiums and may store a rate-calculation trace comprising census row identifier, rate-band identifier, selected rate value, rating rule version, rate-grid source anchor, and calculated result. The trace may populate spreadsheets, premium breakdown sheets, election sheets, enrollment screens, and output manifests.

For life, disability, and other volume-based benefits, the platform may calculate benefit volume, premium volume, guarantee issue amount, age-reduction amount, rate factor, salary-based benefit amount, minimum benefit, maximum benefit, waiting period, elimination period, benefit duration, and employee contribution. The calculations may use census data, salary fields, class definitions, benefit formulas, rate sheets, age bands, reduction schedules, and user-entered or imported rules. Values that are not directly shown in a source document may be stored as computed-origin values linked to the source anchors for the underlying rate factors and formulas.

The five-stage or multi-stage booklet builder may be further configured to receive an approved spreadsheet scenario and automatically create a booklet project using the selected plans, selected coverages, employer contribution rules, rate display settings, booklet branding, page selections, and source-document attachments. In this manner, the same approved scenario that supports an employer-facing online spreadsheet can drive the benefit booklet, election sheets, premium breakdowns, enrollment site, and microsite without redundant data entry.

In some embodiments, the booklet builder includes a template selection module having a plurality of cover pages, page layouts, color schemes, fonts, stock images, section headings, icon sets, table layouts, and back-cover layouts. A tenant may set default branding, while a company or project may override branding according to permission. Template selections may be stored with template version identifiers and may be included in the output manifest so that a previously generated booklet can be reproduced or invalidated when a template changes.

The booklet builder may include page-order and formatting logic. A user may add, delete, duplicate, rename, hide, show, or reorder pages and uploaded document components. The platform may recalculate page numbers, table-of-contents entries, section headings, component merge order, overflow behavior, and page breaks based on the current component list. When a user hides a row or column in a benefit table, the renderer may expand or reflow remaining rows or columns according to stored layout rules rather than requiring manual formatting.

Uploaded Portable Document Format documents may be treated as booklet components and may be linked to the source-object records from which they were derived. The component list may identify whether a component is a generated page, uploaded attachment, compliance document, legal notice, translated page, carrier document, or back-cover page. The output manifest may identify the component order, component type, source-object hash, generated file hash, page count, table-of-contents entry, and user approval state for each component.

In some embodiments, a translation module translates a booklet, microsite, enrollment site, compliance document, election sheet, or selected output components using source field identifiers rather than merely translating a flat generated document. The translation module may preserve carrier names, plan names, legal terms, dollar values, percentages, dates, defined insurance terms, and tenant-specific phrases according to a controlled term list. A translated output may retain links to the original approved normalized benefit record, source anchors, translation-rule-set version, reviewer approval, and output manifest.

The platform may include a compliance-template and legal-notice library. The library may store template identifiers, jurisdiction, plan type, employer-size conditions, applicability rules, official-source metadata, template version, effective date, review status, retired status, tenant-specific modifications, and required fields. A scheduled freshness process may periodically check configured official-source locations, administrator-provided sources, or internal compliance repositories for notice updates and may flag a template for review, replacement, retirement, or tenant notification.

In some embodiments, a legal-notice selection engine applies rules to company, plan, coverage-line, jurisdiction, employer-size, employee-class, prescription-drug coverage, Medicare-creditable-coverage, wellness-program, Consolidated Omnibus Budget Reconciliation Act, Health Insurance Portability and Accountability Act, Children's Health Insurance Program, marketplace, women's health, cancer rights, genetic information, and other benefit-related inputs. The engine may recommend, preselect, require, or mark as not applicable one or more notices, while allowing a reviewer to approve or override the recommendation. The rule result, rule version, selected notice, reviewer action, and source or origin of each required field may be stored in the compliance manifest.

Compliance documents such as wrap summary plan descriptions, premium-only-plan documents, broker compensation disclosures, annual legal notices, carrier termination letters, and related artifacts may be generated in the same workflow as booklets and enrollment outputs. Company and plan fields may be populated from the canonical benefit record, company records, source anchors, imported origin values, user-entered values, or computed values. Fields that remain unresolved may block publication of the affected compliance document while allowing unaffected booklet or spreadsheet components to continue to preview or generate.

In some embodiments, the microsite module creates a company-specific or project-specific microsite from the approved normalized benefit record and selected output components. The microsite may include plan overview pages, downloadable booklets, annual legal notices, compliance documents, carrier documents, source-document folders, contact information, recorded videos, frequently asked questions, enrollment deadlines, quick-response-code links, and plan comparison views. Each folder, document, video, link, and page may be represented by a microsite component record linked to a source object, output manifest, access policy, and audit state.

The microsite may support a reduced-booklet workflow. In such a workflow, the generated booklet may provide a concise overview of key benefits, while the microsite stores complete carrier documents, summary of benefits and coverage documents, annual legal notices, compliance documents, forms, and videos in organized folders. The booklet may include a quick response code or signed link to the microsite, and the microsite manifest may identify the source documents and compliance documents available to employees or employer users.

Microsite access may be public, unlisted, password-protected, role-protected, employee-specific, employer-specific, time-limited, plan-year-limited, or tokenized. A publication-access record may store the microsite identifier, component identifier, tenant, company, plan year, permitted audience, expiration time, revocation status, password requirement, token hash, quick-response-code state, view events, download events, and last-access time. The platform may revoke or expire microsite components when a source-document hash, canonical-record version, template version, notice-template version, approval status, or publication setting changes.

The platform may generate proof-of-availability records for selected microsite components. A proof-of-availability record may identify the component, version, publication time, access policy, source-document hash, manifest identifier, publication link, quick-response-code identifier, and access or download events. Such records may be used by tenant administrators to review whether selected materials were made available through the platform, without representing that any particular legal distribution obligation has been satisfied.

In some embodiments, an agency plan library stores approved plan records for reuse across a tenant's block of business. A plan-library record may include carrier, plan name, plan type, normalized benefit fields, source anchors, schema version, template mapping, reviewer approval, quality score, permission scope, and last-used information. The platform may also maintain a carrier plan library of preloaded or curated plan records. Loading a plan from a library may create a copy linked to the library source and may require review when plan-year, rate, eligibility, or source-document information differs from the target project.

The system may distinguish between a sample repository used for extraction guidance and a plan library used for output generation. A sample repository entry may provide structural guidance to map a target document to a schema, whereas a plan-library entry may provide an approved plan that can be copied into a project. Tenant policy may permit, restrict, or prohibit cross-tenant use of sample entries, plan-library entries, source text, structured data, reviewer corrections, or carrier templates.

In some embodiments, the platform supports a prior-year renewal-copy workflow. The platform may copy a prior-year project, prior approved normalized benefit records, prior page selections, prior output templates, prior legal-notice selections, prior microsite structure, prior enrollment settings, prior rate grids, prior carrier contacts, and prior publication settings. The user may then upload current-year source documents, rate grids, carrier responses, or census files, and the platform may extract current-year values, compare them with prior-year values, and route material differences for review.

A renewal comparison engine may highlight changed fields in a review interface. Changed fields may include deductible, out-of-pocket maximum, copayment, coinsurance, prescription tier, network name, carrier name, plan name, eligibility rule, plan-year date, rate tier, employer contribution, employee deduction, life or disability volume, age-reduction schedule, legal-notice applicability, compliance-template version, microsite link, or enrollment deadline. The comparison engine may display prior-year value, current-year candidate value, target-source anchor, confidence, matched-sample leakage indicator, and reviewer action controls.

A change-impact engine may identify which generated outputs are affected by a changed field. For example, a changed medical deductible may affect a booklet plan page, plan comparison spreadsheet, enrollment plan card, microsite overview, and employee-facing plan comparison page, while a changed contribution rule may affect a premium breakdown, election sheet, online spreadsheet scenario, enrollment cost display, and payroll export. The platform may regenerate, revoke, expire, or revalidate only the affected components and links.

In some embodiments, source-anchor coverage maps are maintained at multiple levels of granularity, including field level, row level, table level, page level, output-component level, document level, microsite-folder level, enrollment-screen level, spreadsheet-cell level, and request-for-proposal-field level. A single output component may have a mixed coverage state, with some values source-anchored, some user-entered, some imported, some computed, and some unresolved. The publication gate may apply different blocking rules depending on output type, audience, field criticality, tenant policy, and review status.

The platform may maintain a component-source map for each output. The component-source map may identify which source anchors, origin types, approved-record versions, rate-calculation traces, translation-rule versions, template versions, and reviewer approvals supplied each page, table, row, spreadsheet cell, employee-facing value, employer-facing value, carrier-facing field, microsite component, or enrollment screen. The component-source map may be used to reproduce an output, audit an output, display source evidence to a reviewer, or determine whether a later change affects the output.

In some embodiments, the platform performs stale-output detection. A stale condition may exist when a source-document hash, approved normalized benefit record version, rate-calculation parameter, rate-grid version, census version, contribution scenario, template version, compliance-template version, legal-notice rule version, translation-rule-set version, publication setting, access policy, or reviewer approval differs from the state recorded in an output manifest. A stale condition may cause the platform to display a warning, block publication, disable a link, require reviewer approval, or automatically regenerate affected components.

The platform may allow preview generation before all required fields are approved, while preventing publication of unresolved employee-facing or employer-facing values. For example, a user may preview a draft booklet or draft spreadsheet while missing fields are marked with placeholders or review indicators. The publication gate may then block final output release until required fields are supported by source anchors or approved origins, required calculations are complete, and unresolved leakage-suspected or conflicting values have been resolved.

In some embodiments, manual fallback workflows remain available. A user may manually enter plan details, rate values, contribution rules, compliance inputs, microsite content, or output settings when a source document is unavailable, when extraction confidence is low, when a carrier response is incomplete, or when the tenant policy disables machine-learning extraction. Manually entered values may be stored as user-entered origins with reviewer identity, timestamp, source notes, and audit history, and may be treated differently than source-anchored values in the coverage map.

The platform may include review-prioritization rules for high-risk values. High-risk values may include deductibles, out-of-pocket maximums, rate values, employer contributions, employee payroll deductions, eligibility rules, waiver text, plan-year dates, carrier names, legal-notice applicability, creditable-coverage selections, and compliance-document fields. Such values may require manual confirmation even when extraction confidence is high, or may require secondary approval when changed from a prior-year record.

In some embodiments, the platform supports sensitive-data minimization in request-for-proposal, spreadsheet, extraction, translation, and enrollment workflows. Census rows, dependent data, employee names, dates of birth, salary values, health-related values, payment data, and other sensitive data may be redacted, tokenized, aggregated, or withheld according to tenant policy and the purpose of the operation. External model, parser, translation, email, payment, payroll, carrier, analytics, or monitoring calls may receive only the fields necessary for the authorized operation.

Carrier-facing, employer-facing, employee-facing, agency-facing, and administrator-facing users may each receive separate security contexts and output scopes. A carrier-facing user may be permitted to view only a selected request-for-proposal project and associated line-of-coverage documents. An employer-facing user may be permitted to approve selected spreadsheet scenarios and view microsite components. An employee-facing user may be permitted to view enrollment materials and submit elections. An agency administrator may configure templates, carrier contacts, legal-notice selections, and publication policies. These scopes may be enforced at database query, object-storage, component-rendering, and publication-link layers.

The platform may maintain carrier-dashboard audit events. Such events may include invite creation, link issuance, link view, source-object download, questionnaire view, response upload, proposal submission, clarification request, approval, rejection, winning-carrier selection, losing-carrier notification, expiration, revocation, and manager notification. Audit events may be linked to source-object records, carrier invite records, carrier response records, output manifests, and security-context records.

Representative data objects for the renewal workflow may include RenewalProject, RenewalPhaseState, CarrierInvite, CarrierContactVersion, CarrierSelectionTemplate, CarrierResponseSourceObject, SpreadsheetScenario, EmployerDecision, CensusParticipant, CensusHousehold, RateBand, RateCalculationTrace, VolumeCalculation Trace, BookletComponent, MicrositeComponent, ComplianceTemplateVersion, LegalNoticeRuleResult, PublicationAccessRecord, ComponentSourceMap, and ChangeImpactRecord. The particular names of the records are examples and other names, data structures, database tables, graph nodes, or object types may be used.

In some embodiments, the platform integrates with human-resources information systems, payroll systems, carrier systems, customer relationship management systems, document-signature systems, email systems, text-message systems, analytics systems, payment systems, or printing systems. Integration records may identify external system, tenant, company, direction of data flow, mapped fields, credential scope, data-egress policy, last synchronization state, error state, retry state, and audit history. Integration errors may be isolated to affected components and may not require regeneration of unrelated outputs.

The user interface may provide a unified renewal dashboard showing phase statuses, missing fields, review queue items, carrier response status, spreadsheet scenario status, booklet status, compliance-document status, microsite publication status, enrollment readiness, stale-output warnings, and recent audit events. Selecting a dashboard item may open the relevant source document, source anchor, canonical benefit field, carrier response, census row, rate calculation trace, output component, or publication-access record.

In some embodiments, a user interface provides side-by-side or multi-pane review of a target source document, matched-sample information, extracted candidate fields, prior-year values, spreadsheet scenario values, booklet preview, and coverage-map status. Selecting a field may scroll a source-document pane to the supporting source anchor, highlight the corresponding output component, and display whether the field is target-source-derived, user-entered, imported, computed, template-derived, leakage-suspected, low-confidence, review-approved, or unresolved.

The platform may support asynchronous and event-driven processing of renewal tasks. Source ingestion, parsing, embedding, sample retrieval, extraction, validation, review notifications, rate calculations, scenario recalculations, booklet rendering, Portable Document Format merging, translation, compliance-template population, microsite generation, enrollment-site generation, spreadsheet export, carrier notification, publication, revocation, and audit-log writing may be processed through queues or event streams. Job states may be displayed to users and may be tied to signed work tokens and manifest states.

In an exemplary request-for-proposal operation, an agency user creates a renewal project, selects medical, dental, vision, life, and disability coverage lines, imports a census spreadsheet, selects carrier contacts from a carrier library, and sends carrier-specific dashboard links. Each carrier receives only the permitted line-of-coverage materials, uploads quote documents through the dashboard, and submits proposal fields. The platform parses the quote documents, validates proposal values against source anchors, imports approved values into a dynamic spreadsheet, and later uses the winning proposal values to generate the benefit booklet, enrollment site, microsite, premium breakdown, and carrier notifications.

In an exemplary online-spreadsheet operation, an employer user opens a signed spreadsheet link, compares plan options, changes employer contribution percentages, selects which plans to offer, and approves a final scenario. The platform stores the approved scenario, recalculates employee and employer costs using rate and census data, creates calculation traces, updates the canonical benefit record or output snapshot, and automatically populates booklet pages, premium breakdown sheets, election sheets, enrollment screens, and microsite plan overviews.

In an exemplary small-client operation, an agency user creates a concise benefit booklet for an employer that does not maintain a separate intranet. The platform generates an overview booklet from canonical plan data, stores carrier documents and legal notices in microsite folders, creates a quick-response-code link to the microsite, applies password or tokenized access if selected, records proof-of-availability events, and stores manifests linking the booklet and microsite components to source-document hashes, template versions, notice-template versions, and publication-access records.

In an exemplary renewal-copy operation, the platform copies a prior-year project and preserves its plan selections, booklet component order, microsite folder structure, legal-notice selections, carrier contacts, and enrollment settings. The agency uploads current-year source documents and rate grids. The platform performs source-anchored extraction, compares current-year values with prior-year values, routes changed or high-risk fields to review, recalculates rates, updates affected components, and blocks publication of stale links until the updated manifest is current.

In an exemplary compliance-freshness operation, a scheduled process detects that a compliance template, notice template, official-source reference, rule version, or tenant-specific notice configuration has changed. The platform identifies generated compliance documents, microsite components, booklets, or enrollment pages that reference the superseded version, marks affected components as stale, notifies authorized users, and permits regeneration or reviewer approval before those components are published or served.

In an exemplary translation operation, a user selects a Spanish or other language translation for a finalized booklet or microsite. The translation module extracts field-level content, applies controlled terms for insurance and compliance phrases, preserves carrier names and plan names, reflows translated text into the selected templates, links translated output components to the original source anchors and approved-record versions, and records a translation-rule-set version in the manifest. If a source value changes after translation, the platform may mark the translated output as stale and require regeneration or review.

In some embodiments, the technical improvement is not merely that a user receives a benefits booklet, spreadsheet, or microsite more quickly. Rather, the platform uses specific computer data structures and validation operations to convert heterogeneous benefit source documents and workflow inputs into source-anchored canonical data, to prevent unsupported sample-derived values from entering downstream outputs, to propagate approved values across multiple artifacts without duplicate entry, to maintain source-to-output provenance, to identify stale or unsupported fields at publication time, and to enforce tenant-scoped access and data-egress controls across internal and external services.

The disclosed embodiments may reduce redundant source parsing, redundant document generation, redundant rate calculation, redundant field entry, and redundant publication review by storing reusable source-object, source-segment, source-anchor, canonical-record, scenario, component-source-map, manifest, and publication-access records. The platform may reprocess only changed source objects, recalculate only affected rate traces, regenerate only affected output components, and revoke only affected publication links, thereby improving computer processing for recurring benefit-renewal workflows.

The renewal-workflow embodiments described in this section are not limited to any particular carrier, plan design, document format, spreadsheet format, language model, vector database, rendering engine, cloud provider, legal-notice source, microsite implementation, or publication mechanism. Any suitable combination of machine-learning extraction, rule-based extraction, user entry, import, computation, review, rendering, storage, audit, and publication operations may be used so long as the platform maintains the described source, origin, validation, versioning, and access-control relationships.

### Further Core Implementation and Drawing-Supported Embodiments

The following embodiments further describe the core implementation of the employee benefit automation platform without relying on shorthand labels. The platform is configured to solve a technical data-processing problem that arises during employee-benefit renewals: heterogeneous carrier documents, rate grids, census records, employer contribution scenarios, legal-notice inputs, prior-year outputs, and carrier proposal responses must be converted into a consistent, validated, source-traceable data state before the data is reused in employee-facing, employer-facing, carrier-facing, and agency-facing outputs.

In some embodiments, the core implementation includes a source-object layer, a source-segment layer, a source-anchor layer, a candidate-field layer, an approved normalized benefit-record layer, a renewal-project state layer, a dependency-graph layer, a source-anchor coverage-map layer, a manifest layer, and a publication-access layer. These layers are maintained as separate but linked computer data structures. The separation permits the platform to determine which source document, source segment, field validation event, reviewer approval, calculation parameter, template version, or access-control event produced each generated output component.

The platform can perform a renewal workflow by first creating a renewal project for a company and plan year, associating the renewal project with selected coverage lines, and assigning required output profiles. Each required output profile identifies the data fields, documents, calculations, approvals, and source-anchor statuses required for one or more outputs. The platform may maintain different required output profiles for a preliminary carrier-marketing package, employer proposal comparison, benefit booklet, compliance document package, microsite, enrollment site, election sheet, premium breakdown, carrier termination letter, and translated output.

In some embodiments, the platform uses a renewal-project state machine. Each phase of the renewal project may have a stored state such as not started, waiting for source documents, waiting for carrier response, extraction in process, review required, approved for proposal, employer decision pending, employer decision approved, booklet generation pending, compliance review pending, publication blocked, published, superseded, revoked, archived, or closed. State transitions may be triggered by user actions, carrier actions, employer actions, employee actions, scheduled freshness checks, validation outcomes, rate-calculation outcomes, template updates, source-document changes, or publication-access changes.

In some embodiments, the renewal dependency graph is a directed data structure in which nodes represent source objects, source segments, source anchors, candidate fields, approved normalized benefit records, rate grids, census records, employer contribution scenarios, carrier responses, spreadsheet scenarios, output components, compliance templates, translation-rule sets, publication links, microsite folders, enrollment screens, employee election records, and manifest records. Edges represent use, derivation, approval, calculation, publication, or access relationships. When a node changes, the platform traverses the dependency graph to identify affected downstream nodes and to mark affected output components as current, stale, review-required, regeneration-required, access-revoked, or unaffected.

The dependency graph may be updated incrementally. For example, when a user changes an employer contribution percentage in an online spreadsheet scenario, the platform can update cost-per-pay-period values, employer-cost summaries, employee deduction rows, booklet rate tables, election sheets, enrollment-screen cost displays, premium breakdown sheets, and microsite plan-summary pages while leaving unrelated legal-notice pages or carrier documents unchanged. Conversely, when a source document hash changes for a medical plan, the platform may require validation of only fields derived from that source document and outputs that display those fields.

A change-impact engine can evaluate graph nodes according to impact rules. Impact rules may specify that a change to a plan name affects booklet headings, spreadsheet columns, enrollment labels, microsite folder names, legal-notice plan references, and carrier termination letters; that a change to an age-banded rate grid affects only participants whose age, dependent status, rating area, class, or tobacco status falls within changed bands; and that a change to a compliance-template version affects only generated compliance documents that used the prior template version.

In some embodiments, a publication gate receives the dependency-graph status, source-anchor coverage-map status, manifest state, security context, publication-access state, and review-queue state before permitting an output to be served, exported, linked, printed, translated, or otherwise made available. The publication gate may prevent release when a required field is unsupported, stale, leakage-suspected, unresolved, calculated from an outdated rate parameter, derived from a superseded template, associated with a revoked source document, outside the permitted role scope, or inconsistent with the current manifest state.

In some embodiments, the platform provides a carrier-facing request-for-proposal dashboard. The dashboard is generated from a carrier invite record that identifies a tenant, company, plan year, requested coverage line, carrier identity, carrier contact version, access scope, due date, required questionnaire fields, source-document package, permitted upload types, password or token requirement, expiration setting, and manifest-bound access state. The carrier-facing dashboard permits a carrier user to review only the company information, census segments, incumbent plan documents, questionnaire fields, and request materials that are within the carrier user access scope.

The carrier-facing request-for-proposal dashboard may segment documents and fields by coverage line. For example, a carrier invited to quote medical coverage can receive medical plan documents, medical census fields, current medical rate information, and medical questionnaire fields, while a carrier invited to quote life or disability coverage can receive life or disability census fields, volume information, salary-related inputs where permitted, and life or disability questionnaire fields. The segmentation prevents unrelated coverage-line materials from being exposed through the same carrier invite unless expressly permitted by the security context and invite record.

Carrier contact records may be versioned and scoped. A carrier contact record may include carrier identity, product line, region, contact name, contact email address, contact role, agency-specific notes, last-confirmed date, created-by user, updated-by user, retired status, and template-group membership. When a carrier contact is updated, future invite records can use the current contact version while prior invite records remain associated with the contact version used when the prior invite was created, thereby preserving auditability.

When a carrier user submits a proposal, rate grid, plan summary, response spreadsheet, or other quote document through the dashboard, the platform stores the submitted item as a source object, assigns a source-document hash, records the carrier user identity and invite identifier, parses the submitted item into source segments, maps response fields to the canonical benefit schema, validates candidate values against the submitted source object, and stores approved or review-required carrier-response fields. The same source-anchoring, leakage-detection, and review workflow used for agency-uploaded documents may be used for carrier-submitted documents.

In some embodiments, the carrier-facing dashboard stores status events. Status events may include invite created, invite sent, link opened, password verified, document viewed, document downloaded, questionnaire started, upload started, upload completed, validation pending, review required, clarification requested, proposal submitted, proposal withdrawn, proposal approved, proposal declined, proposal selected, proposal not selected, invite expired, invite revoked, and project closed. Each status event may include the actor, role, tenant, company, invite identifier, source-object identifier where applicable, timestamp, network address, device information where retained by policy, and event hash.

The dynamic online spreadsheet or web view may be implemented as a scenario-driven decision interface rather than as a static exported spreadsheet. The platform can generate the online spreadsheet from approved normalized benefit records, carrier-response fields, census records, rate grids, contribution formulas, selected coverage lines, class rules, display preferences, and employer-specific permissions. The online spreadsheet may store each employer edit as a versioned spreadsheet scenario rather than overwriting the underlying approved normalized benefit record.

A spreadsheet scenario can include selected plan identifiers, hidden-plan settings, hidden-row settings, hidden-column settings, employer contribution percentages, fixed-dollar employer contribution amounts, class-specific contributions, tier-specific contributions, census-scope selections, rating assumptions, waiver assumptions, renewal-status fields, and display labels. The platform may compute employer monthly cost, employer annual cost, employee monthly contribution, employee cost per pay period, total premium, plan participation assumption, and difference-from-current-plan values for each scenario.

The platform can provide an employer decision workflow. An employer or authorized client user may select a spreadsheet scenario, confirm final plan selections, approve contribution rules, approve display settings, and submit an employer decision. The employer decision may be recorded as an approved scenario version. After approval, the platform may automatically create or update a benefit booklet project, enrollment site, election sheet, premium breakdown sheet, microsite plan overview, carrier-notification record, and customer relationship management renewal status from the approved scenario version.

In some embodiments, the spreadsheet scenario engine calculates age-banded premium values using census participant data and rating rules. Census participant data may include employee identifier, dependent identifier, relationship, date of birth, age as of an effective date, gender where used by a permitted rule, tobacco status where used by a permitted rule, rating area, employee class, coverage tier, spouse status, dependent-child count, adult-child status, salary or volume base where permitted, and waived-coverage status. Rating rules may identify age-band boundaries, child-count rules, adult-dependent rules, composite-rate alternatives, class-based rules, and carrier-specific rounding rules.

For life, disability, and other volume-based benefits, the platform may calculate benefit volume and premium values from salary, selected benefit percentage, minimum benefit, maximum benefit, guarantee issue amount, age-reduction schedule, elimination period, rate factor, class, employee age, coverage tier, and elected volume. Each calculation may store a calculation trace identifying input fields, source anchors or approved origins for those input fields, calculation rule version, intermediate values, rounding method, output value, and reviewer status.

The booklet builder may be implemented as a component-rendering workflow that reads from the approved normalized benefit record and from approved spreadsheet scenario versions. The builder may create generated components including cover page, table of contents, medical plan comparison, dental plan page, vision plan page, life plan page, disability plan page, supplemental benefit page, rate table, payroll deduction table, notes page, legal notice page, compliance document page, quick response code landing page, microsite link page, and back cover page. Uploaded carrier documents can be stored as separate components and merged according to the approved component order.

The booklet builder can maintain a component manifest for each generated booklet. The component manifest may identify component type, component order, page-count contribution, source template, template version, fields used, source anchors used, approved-record version, spreadsheet scenario version, rate-calculation rule version, translation-rule-set version where applicable, rendering engine version, generated component hash, and merge status. The platform can use the component manifest to regenerate only selected pages when a field, rate, contribution rule, or template changes.

The platform may automatically recalculate page numbers and table-of-contents entries when generated pages, uploaded documents, hidden rows, hidden columns, carrier documents, legal notices, translated pages, or back-cover components are added, removed, reordered, hidden, or shown. The recalculation may use component page-count values and merge-order values rather than requiring the user to manually update page numbers or table-of-contents entries.

In some embodiments, the compliance-template and legal-notice library is implemented as a versioned content and rule library. A library record may include template identifier, template version, document category, jurisdiction, plan-year applicability, employer-size condition, plan-type condition, coverage-line condition, prescription-drug-coverage condition, wellness-program condition, effective date, last-reviewed date, official-source reference, tenant override status, required input fields, output-format rules, and stale-template flag.

A scheduled freshness process can evaluate compliance-template and legal-notice records at predetermined intervals. The process may retrieve official-source metadata, compare a stored template version or last-reviewed date to a current version indicator, flag a template for review, block use of a stale template, notify an administrator, and identify generated outputs whose manifest records reference the stale template. The platform may then require regeneration, reapproval, or republication of affected compliance documents or microsite legal-notice folders.

The legal-notice selection engine may apply rules to company state, company size, plan year, coverage lines, selected plans, prescription-drug coverage, creditable-coverage status, wellness-program status, dependent eligibility, group health plan status, employee classes, employer contribution structure, and tenant-specific selections. The engine may record rule identifiers and rule outcomes in the source-anchor coverage map or manifest so that a later reviewer can determine why a notice or compliance document was included or excluded.

The microsite module may create a company-specific or project-specific hosted site from approved normalized benefit records, generated booklet components, uploaded carrier documents, compliance documents, legal notices, contact records, videos, links, quick response code landing pages, enrollment links, and frequently asked question pages. Each microsite component may have a component identifier, folder identifier, source object or generated-output reference, publication state, access scope, expiration setting, view-count setting, download setting, version identifier, and manifest reference.

The microsite may support a reduced-booklet workflow in which the generated benefit booklet contains a concise overview, while complete carrier documents, summary of benefits and coverage documents, certificates, legal notices, compliance documents, enrollment forms, videos, and links are stored in organized microsite folders. The platform can generate a proof-of-availability record that identifies a microsite component, its version, when it was available, which publication link served it, which access rule applied, and whether the component was later revoked, replaced, or archived.

In some embodiments, publication access is bound to a manifest record. A publication access record may include tenant identifier, company identifier, plan-year identifier, output identifier, manifest identifier, approved-record version identifier, employee identifier where applicable, employer user identifier where applicable, carrier invite identifier where applicable, permitted action, permitted audience, expiration time, revocation status, password requirement, device restriction, network restriction, token hash, cryptographic signature, created-by user, and last-access time. The publication service verifies this record before serving a booklet, microsite component, enrollment page, spreadsheet scenario, request-for-proposal package, or downloadable document.

The publication gate may perform manifest-currentness checks. The checks may compare a current source-document hash, source-anchor coverage-map version, approved-record version, schema version, template version, page-order version, rate-calculation rule version, spreadsheet scenario version, legal-notice template version, translation-rule-set version, review-approval status, and publication setting to the corresponding values stored in the manifest. When a mismatch is detected, the publication gate may block access, display a stale-output warning, require review, revoke a link, expire a token, or trigger regeneration of affected components.

In some embodiments, the extraction model interface is configured to avoid using a matched sample as a source of target values. The extraction instruction set can include target source text, target table structure, target segment identifiers, matched sample text, matched sample structured data, schema field definitions, normalization rules, leakage-control instructions, and required source-location fields. The extraction model interface may reject model output that fails to provide a target-source location for a non-missing value when the schema requires source evidence.

The source-anchor validator may use exact matching, normalized matching, table-position matching, synonym matching, coordinate-region matching, string-distance matching, and computed-equivalent matching to determine whether a candidate value is supported by target source segments. The validator may separately compute a target-evidence score and a sample-leakage score. A candidate field may be marked as leakage-suspected when the candidate value is strongly associated with a matched sample or prior-year record and weakly associated with the target source object or another approved origin.

A reviewer interface may present the target source document, highlighted target source segments, candidate fields, normalized values, confidence scores, matched-sample context, prior-year values, coverage-map status, rule messages, and downstream impacted outputs. The reviewer may approve, correct, reject, mark not applicable, request additional documents, select a controlling source, split a field, merge fields, or annotate an exception. Reviewer actions may update the approved normalized benefit record, source-anchor coverage map, dependency graph, and manifest state.

In some embodiments, the sample repository is updated only after permission checks and quality checks. A candidate sample record may include corrected target text, corrected structured fields, source anchors, schema version, reviewer-quality score, tenant-permission scope, sensitivity classification, exclusion rules, and quality-control status. Employee identifiers, dependent identifiers, salary values, protected health information, and tenant-private source content may be excluded from cross-tenant retrieval unless an applicable tenant policy permits broader use.

The platform may include a data-minimization layer for external services. Before invoking an external parser, language model, translation service, payment service, email service, payroll service, carrier service, analytics service, monitoring service, or other integration, the platform can evaluate a tenant-specific data-egress policy, remove fields not needed for the external operation, redact or tokenize sensitive fields, limit the text or structured data transmitted, enforce endpoint restrictions, record retention settings, and write a data-transfer audit event.

The security architecture can bind each source upload, parsing job, sample retrieval, extraction instruction, model invocation, validation event, reviewer action, carrier invite, employer decision, employee enrollment session, output generation job, publication action, external-service call, and application programming interface request to a tenant-scoped security context. The security context may include tenant identifier, user identifier, role identifier, permitted company scope, permitted source-object scope, permitted sample-library scope, permitted output scope, permitted employee scope, authentication assurance level, session identifier, issued-at time, expiration time, policy identifiers, and revocation state.

In some embodiments, a background worker must validate a signed capability token before reading source-document bytes, writing parsed segments, retrieving samples, invoking an extraction model, rendering an output, sending a notification, transmitting data to an external service, or publishing a link. The capability token may identify a tenant, company, plan year, source object, source-document hash, approved-record version, manifest, permitted operation, requesting user or service principal, job identifier, issued-at time, expiration time, and policy version. The worker may refuse execution when the token state differs from current database state.

Audit records may be stored in an append-only or hash-linked log. Each audit record may include event type, actor, role, security context identifier, tenant identifier, company identifier, source-object identifier, approved-record version, manifest identifier, generated-output hash, before-and-after values where applicable, timestamp, event hash, and prior-event hash. The platform may verify the event hash chain to detect missing, modified, reordered, or unauthorized audit events.

The user interface may avoid shorthand by displaying functionally descriptive labels such as request-for-proposal package, carrier-response dashboard, dynamic proposal spreadsheet, approved employer contribution scenario, source-anchor validation, source-anchor coverage map, publication gate, benefit booklet builder, compliance document generator, microsite publication, enrollment workflow, employee election sheet, premium breakdown sheet, and output manifest.

The core implementation is not limited to producing faster documents or more attractive presentations. The technical implementation converts unstructured and semi-structured renewal inputs into source-addressable, validation-controlled, versioned data structures; controls whether that data can be reused in downstream outputs; detects when values are copied from matched samples without target-source support; computes rate and contribution values with calculation traces; and prevents stale or unsupported values from being published through manifest-bound access controls.

In one exemplary operation corresponding to the renewal dependency graph drawing, a user copies a prior-year renewal project, uploads current-year carrier documents and rate grids, imports a current census, and starts extraction. The platform stores each upload as a hashed source object, parses the documents into source segments, retrieves structurally similar samples, extracts candidate benefit values under target-source-only constraints, compares the values to prior-year records, routes changed or unsupported values to review, updates the approved normalized benefit record, recalculates affected rate scenarios, and marks stale prior-year booklet, microsite, enrollment, and spreadsheet outputs as regeneration-required.

In one exemplary operation corresponding to the carrier-facing request-for-proposal dashboard drawing, an agency user selects carriers and coverage lines, and the platform creates invite records. Each carrier receives a protected link to a dashboard limited to the coverage lines selected for that carrier. A carrier user uploads a quote package, and the platform stores the quote package as a source object, extracts and validates quote fields, updates the proposal comparison, records status events, and notifies authorized users when the carrier response is complete.

In one exemplary operation corresponding to the dynamic online spreadsheet drawing, an employer user reviews plan options and contribution scenarios through a signed link. The employer user changes a contribution value and selects final plan options. The platform stores the selection as an approved spreadsheet scenario, recalculates cost values, updates employee deduction data, creates a booklet project, generates election sheets and premium breakdown sheets, updates an enrollment site, and stores a manifest linking each updated output to the approved scenario version.

In one exemplary operation corresponding to the publication gate drawing, a user attempts to publish a microsite and enrollment site. The publication gate evaluates the source-anchor coverage map, review queue, dependency graph, legal-notice template freshness, approved-record version, rate-calculation rule version, security context, access-token status, and manifest state. If the gate detects a stale legal-notice template or an unresolved leakage-suspected field, the platform blocks publication of the affected component while allowing unaffected components to remain available if permitted by policy.

The core-implementation and drawing-supported embodiments described in this section can be combined with any ingestion, parsing, extraction, validation, review, rate-calculation, request-for-proposal, spreadsheet, booklet, compliance, microsite, enrollment, translation, publication, security, audit, or sample-library embodiment described elsewhere in this disclosure.

### Further Finalization, Claim-Enablement, and 360-Degree Implementation Embodiments

The following embodiments provide additional implementation support for claim enablement, avoidance of shorthand, source-to-output traceability, renewal-workflow operation, security, publication control, and drawing-correlated understanding of the disclosed platform. These embodiments are additive to the embodiments described above and may be combined with any source ingestion, parsing, extraction, validation, review, rate-calculation, request-for-proposal, spreadsheet, booklet, compliance, microsite, enrollment, translation, publication, audit, security, or sample-library embodiment described in this disclosure.

A renewal source material data set may include any electronic file, form input, uploaded document, imported document, prior-year output, carrier response, quote package, rate grid, census file, employer contribution instruction, legal-notice input, compliance-template selection, enrollment file, employee election record, or spreadsheet scenario that supplies or affects information used in an employee-benefit renewal. The platform can process each renewal source material according to a document type, input type, source-object type, user-entered origin type, imported origin type, computed-origin type, template-origin type, or review-approved exception type.

For each electronic document within the renewal source material data set, the source-document ingestion service creates a source-object record. The source-object record may store file bytes or an object-storage key, a source-object identifier, tenant identifier, company identifier, plan-year identifier, document-type identifier, coverage-line identifier, carrier identifier when available, original filename, uploader identifier, upload timestamp, parser status, media type, page count, effective date, storage location, cryptographic hash, key identifier, access-control policy identifier, and superseded-document state.

The parsing service converts a source object into source-segment records so that later values are not stored merely as untraceable text. A source-segment record may identify a page, paragraph, line, text span, coordinate region, image region, table, table row, table cell, heading, footnote, rate-tier row, benefit row, eligibility paragraph, prescription-drug table, employer-contribution table, carrier-contact block, or legal-notice section. The segment record may store page number, coordinate values, row identifier, column identifier, character offsets, extracted text, optical-character-recognition confidence, table relationship, neighboring-segment relationship, parser version, and source-document hash.

A source-anchor record is created when a value is supported by one or more source segments or by another approved origin. The source-anchor record may include source-object identifier, source-document hash, segment identifier, page number, table identifier, row label, column label, coordinate region, character range, extracted target text, normalized value, schema field identifier, parser version, validation rule identifier, confidence value, reviewer status, and creation timestamp. The source-anchor record permits a generated booklet value, spreadsheet cell, enrollment value, compliance-document value, microsite value, or carrier-facing value to be traced to its supporting source.

A source-anchor coverage-map record identifies, for each required field, optional field, generated page, generated table, spreadsheet cell, enrollment-screen value, request-for-proposal field, microsite folder item, compliance-document field, publication link, or output component, whether the item is supported by a source anchor, user-entered origin, imported origin, computed origin, template-derived origin, review-approved exception, or unresolved status. The coverage-map record may store field identifier, component identifier, output type, origin type, source-anchor identifier, source-document hash, confidence value, review state, blocking state, exception reason, required-field rule identifier, last-validation timestamp, and approved-record version.

Each output type may have a required-output profile. A required-output profile defines the fields, records, source anchors, calculation traces, review approvals, template versions, access settings, and publication conditions needed before that output type can be published or served. For example, a preliminary proposal-comparison spreadsheet may require plan name, carrier name, coverage line, rate tiers, and selected high-level benefit values, while an enrollment site may additionally require eligibility rules, waiver text, per-pay-period cost values, dependent rules, deadline text, and employee-facing disclosure fields.

A manifest data record may be created for each generated output, output package, generated component, publication link, spreadsheet scenario, request-for-proposal package, microsite folder, enrollment site, translated output, or quick-response-code-linked artifact. The manifest data record may identify source-object identifiers, source-document hashes, source anchors, source-anchor coverage-map version, approved-record version, schema version, template version, page-order version, rate-calculation rule version, spreadsheet scenario version, legal-notice template version, translation-rule-set version, extraction-instruction version, parser version, model identifier, reviewer approvals, generated-output hash, publication setting, access scope, expiration state, revocation state, and dependency-graph status.

A publication gate is a rule-execution and state-verification process that evaluates the source-anchor coverage map, required-output profile, review-queue state, matched-sample leakage status, manifest data record, renewal dependency graph, legal-notice freshness state, security context, signed-link state, token state, and publication-access record before an output is served, exported, linked, or made available. The publication gate may block all or part of an output when a required field is unsupported, unresolved, leakage-suspected, stale, expired, revoked, outside the permitted access scope, or inconsistent with the current manifest state.

A tenant-scoped security context may be created after authentication and may be applied to each platform operation. The security context may include tenant identifier, user identifier, role identifier, permitted company scope, permitted source-object scope, permitted sample-library scope, permitted output scope, permitted employee scope, permitted carrier-invite scope, authentication method, authentication-assurance level, session identifier, issued-at time, expiration time, policy identifiers, revocation state, and device or network attributes. The platform may reject an operation when the requested tenant, company, source object, manifest, output, enrollment record, carrier invite, or employee record is outside the permitted scope.

A signed capability token may be issued to a worker process for asynchronous operations. The capability token may identify tenant, company, plan year, source object, source-document hash, approved-record version, manifest, operation type, output type, requesting user or service principal, queue name, job identifier, issued-at time, expiration time, policy version, and revocation state. A worker can validate the token signature and compare the token state with current database state before reading source-object bytes, writing parsed segments, retrieving samples, invoking an extraction model, rendering an output, transmitting data to an external service, sending a notification, or publishing a link.

A tenant-specific data-egress policy controls data transmission to external systems. The policy may identify approved endpoints, permitted data classes, permitted fields, prohibited fields, field-minimization rules, redaction rules, tokenization rules, retention settings, model-use restrictions, sample-library restrictions, geographic restrictions, consent requirements, logging requirements, and approval requirements. Before external transmission, the platform may omit, redact, tokenize, aggregate, or withhold source text, employee data, dependent data, salary values, census values, protected health information, rate data, generated output data, audit data, or tenant-private source content that is not permitted for the target endpoint.

The extraction-instruction service assembles target source text, target segment identifiers, target table structures, target layout metadata, matched sample text, matched sample structured data, canonical schema fields, data types, normalization rules, leakage-control instructions, fallback-origin rules, and source-location return requirements. The extraction instructions may state that matched samples provide structural guidance and field-mapping guidance only, and that values for the target source object must be supported by target source segments or another approved origin.

Numerical vector representations may be generated from full-document text, selected source segments, table headings, row labels, column labels, plan names, carrier names, coverage-line identifiers, effective dates, rate-tier labels, benefit-field labels, source-document type, layout features, and candidate field groups. The sample-matching service may search a vector index, keyword index, rules-based index, or hybrid index to retrieve matched samples using vector similarity, carrier similarity, plan-type similarity, coverage-line similarity, layout similarity, schema-version compatibility, tenant permission, and reviewer-quality score.

A matched sample is not a value source for the target document unless separately approved as an imported origin or user-approved origin. The platform can store, in the extraction-instruction version and audit log, that matched sample fields were used for structure, field order, field naming, row interpretation, column interpretation, and normalization guidance. The validator may reject or route for review any non-missing candidate value that lacks a target-source location or approved origin even when the value appears plausible in view of a matched sample.

Matched-sample leakage detection may calculate a target-evidence score and a sample-leakage score. The target-evidence score may be based on exact value matching, normalized value matching, synonym matching, table-position matching, coordinate-region matching, string-distance matching, and computed-equivalent matching against the target source segments. The sample-leakage score may be based on similarity between the candidate value and values in matched samples, prior-year records, example records, or retrieved structural samples. A candidate field may be marked leakage-suspected when the sample-leakage score exceeds a threshold and the target-evidence score is below a threshold.

The review queue may display a candidate field, field label, proposed value, normalized value, confidence value, target-source excerpt, highlighted page or table region, proposed source location, matched-sample context, prior-year value, validation message, leakage reason, required-output profile impact, downstream impacted outputs, and available reviewer actions. Reviewer actions may include approve, edit, reject, mark not applicable, request another document, select a controlling source, split a field, merge fields, create an exception, annotate an exception, or escalate the item to another user.

An approved normalized benefit record may be stored only after automatic validation or reviewer approval. The record may include plan identity, carrier identity, coverage line, plan year, network values, deductible values, out-of-pocket maximum values, copayment values, coinsurance values, prescription values, eligibility rules, rate values, contribution rules, payroll-deduction settings, compliance selections, source anchors, confidence values, reviewer status, version identifier, tenant identifier, company identifier, source-document hashes, audit events, and dependency-graph links.

The renewal dependency graph may include nodes representing source objects, source segments, source anchors, candidate fields, approved normalized benefit records, plan-library records, rate grids, census records, employer contribution scenarios, carrier invite records, carrier response source objects, spreadsheet scenarios, booklet components, compliance templates, legal-notice templates, translation-rule sets, microsite folders, enrollment screens, employee election records, carrier-notification records, publication links, access records, and manifest records. Edges may identify data derivation, calculation dependency, template dependency, publication dependency, approval dependency, access dependency, or notification dependency.

The change-impact engine may traverse the renewal dependency graph when a source-document hash, approved-record version, rate-grid version, census row, contribution rule, employer decision, carrier response, template version, legal-notice freshness state, translation-rule-set version, publication setting, security policy, or access record changes. The engine may mark downstream outputs as current, stale, review-required, regeneration-required, access-revoked, expired, revalidation-required, notification-required, or unaffected. The engine may regenerate, revoke, expire, or revalidate only affected output components when policy permits selective remediation.

A carrier-facing request-for-proposal dashboard may be generated from carrier invite records rather than from a blank email or an undifferentiated attachment package. A carrier invite record may store carrier identifier, carrier contact version, requested coverage lines, permitted document categories, due date, questionnaire fields, source-object permissions, permitted upload types, password requirement, signed-token requirement, expiration setting, revocation setting, status state, and audit identifiers. The dashboard may show only the source documents, census segments, questionnaire fields, current plan information, and project information permitted for that carrier and coverage line.

Carrier response processing may store each carrier-submitted proposal, plan summary, quote spreadsheet, rate grid, questionnaire answer, proposal note, or supporting document as a source object associated with the renewal project. The platform may parse the carrier response source object, extract proposal fields, normalize the proposal fields to the canonical benefit schema, create source anchors for supported values, route unsupported or conflicting values to review, update request-for-proposal status events, and use approved response values in proposal comparisons, online spreadsheet scenarios, booklets, microsites, enrollment screens, and carrier notifications.

The dynamic online spreadsheet scenario engine may generate a scenario-driven web view from approved normalized benefit records, carrier-response fields, rate grids, census records, contribution formulas, selected coverage lines, class rules, employer display preferences, and source-anchor indicators. A spreadsheet scenario may store selected plan identifiers, hidden-plan settings, hidden-row settings, hidden-column settings, employer contribution percentages, fixed-dollar employer contribution amounts, class-specific contributions, tier-specific contributions, census-scope selections, rating assumptions, waiver assumptions, renewal-status fields, display labels, and calculated employer and employee cost values.

An employer decision record may be created when an employer or authorized client user approves plan selections, contribution rules, display settings, or spreadsheet scenario values. The employer decision record may store tenant identifier, company identifier, plan year, selected plans, approved contribution settings, spreadsheet scenario version, approving user, approval timestamp, client-facing display state, review exceptions, and publication instructions. The approved employer decision may trigger booklet generation, compliance-document generation, microsite updates, enrollment screen generation, election sheet creation, premium breakdown creation, and carrier result notifications.

The rate and census calculation service may calculate premiums, employer contributions, employee contributions, payroll deductions, and total cost values from monthly premium values, employee premium values, employer contribution values, contribution percentages, fixed-dollar contributions, number of pay periods, premium frequency, deduction frequency, rate type, rate tier, coverage class, selected coverages, dependent counts, employee attributes, waiver selections, class rules, and plan-year effective dates. Each calculated value may store a calculation trace identifying input records, formula version, assumptions, rounding method, and output fields populated.

For age-banded rates, the platform may compute each participant age as of a configured effective date, match the age to an age-band row, associate the participant with a coverage tier or dependent grouping, retrieve the applicable rate, apply contribution rules, and aggregate results by employee, dependent, class, plan, tier, or employer scenario. The calculation trace may identify the census row, date-of-birth field, effective date, age-band table, rate row, coverage tier, contribution rule, and generated employee or employer cost value.

For life, disability, and other volume-based benefits, the platform may calculate benefit volume and premium values from salary, benefit percentage, flat benefit amount, guaranteed issue limit, maximum benefit limit, minimum benefit limit, age-reduction schedule, rate factor, benefit duration, elimination period, occupation class, coverage class, and selected coverage amount. The calculation output may be used in booklets, election sheets, premium breakdowns, enrollment screens, proposal comparisons, and customer relationship management records.

The benefit booklet builder may generate a component list comprising covers, table of contents, plan pages, comparison pages, definition pages, note pages, annual legal notices, compliance documents, uploaded Portable Document Format attachments, translated components, quick-response-code pages, and back covers. When a user adds, removes, hides, reorders, renames, duplicates, or replaces a component, the platform may update component order, page counts, table-of-contents entries, page-number values, source-anchor coverage-map entries, component manifests, and stale-output status.

The compliance-template and legal-notice service may maintain a library of notice templates and compliance-document templates. A template record may store template identifier, template type, template version, jurisdiction, plan-year applicability, employer-size condition, plan-type condition, coverage-line condition, prescription-drug condition, effective date, last-checked date, source reference, template-status value, required fields, and blocking rules. The platform may schedule freshness checks, mark templates as current or stale, route stale templates to review, and prevent publication of affected compliance components when a required template is stale or superseded.

The microsite service may create company-specific web pages, folder structures, document libraries, link groups, video records, contact records, notice folders, compliance-document folders, carrier-document folders, and quick-response-code landing pages. A microsite proof-of-availability record may store manifest identifier, component identifier, document identifier, access policy, publication timestamp, expiration timestamp, revocation timestamp, last-access timestamp, access-count data, and employee-facing or employer-facing availability state.

The enrollment workflow may generate employee-facing plan option pages, cost-per-pay-period values, eligibility information, dependent-entry fields, waiver controls, acknowledgment controls, downloadable benefit documents, legal-notice links, deadline text, confirmation screens, and administrative dashboards from approved normalized benefit records and rate-calculation traces. Employee elections, waiver selections, dependent entries, acknowledgments, confirmation entries, and completion states may be stored in enrollment records linked to the approved-record version and manifest.

The customer relationship management functionality may store companies, contacts, renewal projects, agents, carrier contacts, employer contacts, employees, dependents, request-for-proposal statuses, spreadsheet scenario statuses, enrollment statuses, tasks, notes, opportunities, document links, publication links, payment status, audit events, and generated-output history. Updates from request-for-proposal, spreadsheet, booklet, microsite, enrollment, and carrier-notification workflows may write to customer relationship management records without requiring separate re-entry.

Translation generation may preserve source and field relationships. The platform may extract text from an approved output, map extracted text to schema fields or component identifiers, apply translation rules and controlled insurance terminology, preserve carrier names and plan names where policy requires, render translated components, store translation-rule-set versions, and create a translated-output manifest linked to the original approved-record version and source-anchor coverage map.

The sample repository may be updated only after permission checks, sensitivity checks, and quality checks. A candidate sample record may include corrected target text, corrected structured fields, source anchors, schema version, reviewer-quality score, tenant-permission scope, sensitivity classification, exclusion rules, quality-control status, and sample-library scope. Employee identifiers, dependent identifiers, salary values, protected health information, and tenant-private source content may be excluded from cross-tenant retrieval unless an applicable tenant policy permits broader use.

Audit records and manifest records may be stored in an append-only or hash-linked log. Each audit record may include event type, actor, role, security context identifier, tenant identifier, company identifier, affected object identifier, source-document hash where applicable, approved-record version where applicable, manifest identifier where applicable, generated-output hash where applicable, before-and-after values where applicable, timestamp, event hash, and prior-event hash. The platform may verify the event hash chain to detect missing, modified, reordered, inserted, or unauthorized audit events.

User-interface labels, output labels, schema labels, manifest labels, and administrative labels may be functionally descriptive rather than shorthand-only labels. For example, the platform may identify a request-for-proposal package, carrier-response dashboard, dynamic proposal spreadsheet, approved employer contribution scenario, source-anchor validation record, source-anchor coverage map, publication gate, benefit booklet builder, compliance document generator, microsite publication page, enrollment workflow, employee election sheet, premium breakdown sheet, customer relationship management record, and output manifest by expanded descriptive names. Abbreviations may be displayed only when the expanded term is also stored or otherwise defined.

The drawing-correlated implementation may be supported by at least the following drawing concepts: a secure multi-tenant deployment environment; a module and data-store diagram; an integrated benefit-output workflow; a source-anchored retrieval-augmented extraction flow; a renewal-project state machine and renewal dependency graph; a carrier-facing request-for-proposal dashboard; a dynamic online spreadsheet scenario engine; and a manifest-bound publication gate. The drawings may use labeled boxes, flow arrows, data-store symbols, access-control paths, and state-transition labels to show every claimed feature that benefits from visual explanation.

In relation to the independent method claim, the detailed description enables receiving renewal source materials, storing hashed source objects, parsing source segments, generating numerical vector representations, retrieving matched samples, creating target-source-constrained extraction instructions, obtaining candidate structured benefit data, validating and source-anchoring candidate fields, detecting matched-sample leakage, routing exceptions to review, storing approved normalized benefit records, generating employee benefit outputs, creating source-anchor coverage maps, creating manifest data records, and preventing publication of unsupported or stale fields.

In relation to the independent system claim, the detailed description enables an identity and tenant-permission service, source-document ingestion service, parsing service, sample-matching service, extraction-instruction service, extraction model interface, validation and review service, approved normalized benefit data store, renewal dependency graph service, output services, and manifest, audit, and publication service. The disclosure identifies representative data records, state fields, security controls, service interactions, inputs, outputs, and failure conditions for those services.

In relation to the independent non-transitory computer-readable storage medium claim, the detailed description enables maintaining approved normalized benefit records, maintaining source-anchor coverage maps, generating publication artifacts, creating manifest data records, creating or validating access records, receiving access requests, evaluating the publication gate, preventing unauthorized or stale access, collecting enrollment entries, applying data-egress policies, and writing audit and manifest records to an append-only or hash-linked log.

The platform may be implemented as a monolithic application, distributed service architecture, serverless workflow, worker-queue architecture, browser-and-server application, containerized service set, cloud-hosted environment, on-premises deployment, hybrid deployment, or other processor-executed software architecture. The described services may communicate through database transactions, application programming interfaces, message queues, event streams, webhooks, file exchanges, remote model calls, internal model calls, rendering engines, parsing engines, object-storage calls, and relational database operations.

In one end-to-end operation, an agency user creates a renewal project, uploads current-year summary of benefits and coverage documents, uploads rate grids, imports a census file, copies prior-year outputs, selects carriers for a request-for-proposal phase, and starts extraction. The platform stores the uploaded files as hashed source objects, parses them into source segments, retrieves structurally similar samples, creates target-source-constrained extraction instructions, validates candidate fields, detects leakage-suspected values, routes exceptions to review, creates approved normalized benefit records, calculates rates, generates a dynamic proposal spreadsheet, receives an employer decision, and generates a booklet, compliance documents, microsite, enrollment screens, election sheets, premium breakdowns, and carrier notifications with manifest-bound publication controls.

The technical implementation is not limited to presenting benefit information more quickly. The implementation transforms heterogeneous documents and renewal inputs into source-addressable records, source-anchored field evidence, approved normalized benefit records, coverage-map records, dependency-graph records, calculation traces, manifest records, access records, and hash-linked audit records. Those records are then used to control extraction reliability, review routing, output generation, stale-output detection, selective regeneration, secure publication, and downstream reuse across multiple benefit-renewal outputs.

The embodiments in this finalization section may be combined with any previously described embodiment and with the claim elements in any technically compatible combination. The order of operations may vary, operations may be performed synchronously or asynchronously, and one physical or logical service may perform functions described as multiple services when the same data records, validation operations, source-anchor operations, manifest operations, security-context operations, and publication-gate operations are preserved.

### Further Final Claim-Support and Formalization Embodiments

The following finalization embodiments define the functional steps and services using descriptive names rather than shorthand labels. Where an interface label in a commercial product may use a shorter label, the underlying stored record and functional description can use the expanded functional name. For example, a carrier request package can be represented as a request-for-proposal project record, and a client relationship record can be represented as a customer relationship management record.

In some embodiments, receiving renewal source materials includes receiving files, spreadsheet rows, browser-form submissions, carrier-dashboard uploads, employer decision inputs, employee election inputs, and imported records through authenticated browser sessions, application programming interface requests, worker jobs, file imports, or integration events. The platform validates the tenant, company, plan year, role, file type, and permitted operation before the received item becomes a source object or input record.

In some embodiments, storing a received file as a source object includes storing binary file content or a pointer to object storage, computing a cryptographic hash from the original bytes, assigning identifiers, recording upload metadata, retaining source-document type and plan-year metadata, and preventing later generated outputs from using untracked file content. A replacement source document is stored as a new version rather than silently overwriting the prior source-object state.

In some embodiments, parsing a source object into source segments includes extracting text, tables, rows, columns, coordinates, headings, footnotes, embedded images, and optical-character-recognition output as addressable records. The platform may use a parser version, page number, coordinate region, table identifier, character offset, extracted string, and neighboring-segment relationships so a field can be traced to a specific source location.

In some embodiments, generating numerical vector representations includes encoding source text, table labels, layout features, carrier names, plan names, coverage lines, effective dates, and candidate field labels into numeric arrays used for similarity comparison. The numerical vector representation is stored or cached with source-object or source-segment identifiers and is not itself treated as an approved benefit value.

In some embodiments, retrieving matched samples includes selecting structurally similar previously processed documents while enforcing tenant permissions and sensitivity classifications. Matched samples guide field layout and schema mapping but are not authoritative sources for the target plan values.

In some embodiments, creating extraction instructions includes combining target text, matched-sample structure, schema field definitions, permitted data types, normalization rules, source-location requirements, missing-field rules, and leakage-control rules. The instruction set may require the extraction model to return a value, source-location proposal, confidence indication, and missing or review-required status for each field.

In some embodiments, validating candidate structured benefit data includes comparing the candidate value to target source segments, normalizing and checking data types, checking cross-field consistency, detecting rate-calculation errors, detecting conflicting documents, assigning confidence, detecting matched-sample leakage, and creating source anchors. Validation may be automatic, review-assisted, or both.

In some embodiments, routing to review includes creating a review-queue record, displaying evidence and blocking reasons, recording reviewer actions, and updating the approved normalized benefit record only after a permitted review action or automatic approval rule. Review records distinguish corrections, overrides, exceptions, not-applicable determinations, source selections, and requests for additional documents.

In some embodiments, generating employee benefit outputs includes rendering templates, calculating rates, merging uploaded and generated documents, creating web pages, creating spreadsheet artifacts, creating enrollment controls, creating translated components, creating carrier notifications, creating legal-notice artifacts, and writing component-source maps from the approved normalized benefit record and associated calculation traces.

In some embodiments, creating a source-anchor coverage map includes mapping each required output field, table, page, spreadsheet cell, enrollment screen value, microsite item, notice field, request-for-proposal field, or carrier-response field to a source anchor, user-entered origin, imported origin, computed origin, template-derived origin, review-approved exception, or unresolved status.

In some embodiments, creating a manifest data record includes recording source-object hashes, approved-record versions, template versions, schema versions, parser versions, extraction-instruction versions, model identifiers, calculation-rule versions, translation-rule versions, reviewer approvals, generated-output hashes, publication settings, access scopes, expiration states, revocation states, and component-source maps for the generated artifact.

In some embodiments, preventing publication includes refusing to serve, export, link, display, transmit, print, or otherwise make an output component available when the publication gate detects an unsupported required field, unresolved review item, leakage-suspected value, stale source-document hash, stale approved-record version, stale template version, stale calculation-rule version, stale translation-rule version, expired access token, revoked access record, or scope-inconsistent request.

A claim element that refers to a service, engine, module, gate, graph, map, store, record, dashboard, web view, interface, or workflow refers to processor-executed instructions and associated stored data records configured to perform the described operation. Such elements are not merely visual screen labels; each corresponds to stored identifiers, state values, permissions, inputs, outputs, validation rules, audit events, or access-control checks described in this specification.

Any drawing package prepared for filing may depict the described functional elements as logical blocks, data stores, flows, state transitions, access-control paths, or publication-gate decisions. The drawings need not show source code or screen artwork, provided the drawing labels and reference numerals correspond to the structures, records, services, and operations described in this specification and recited in the claims.

What is claimed is:

1. A computer-implemented method performed by one or more processors of a multi-tenant employee benefit automation platform for converting renewal source materials into validated employee benefit outputs, the method comprising:
receiving, from an authenticated user associated with a tenant organization, one or more benefit source documents and renewal inputs for a company and plan year, the one or more benefit source documents and renewal inputs comprising at least one of a plan summary, summary of benefits and coverage document, rate sheet, carrier certificate, carrier proposal, prior-year booklet, spreadsheet, census file, employer contribution input, legal-notice input, or enrollment file; storing each received benefit source document as an electronically stored source object comprising file bytes or an object-storage key, a source-object identifier, tenant identifier, company identifier, plan-year identifier, document-type identifier, original filename, uploader identifier, upload timestamp, parser status, and cryptographic hash calculated from the file bytes; parsing each source object into source segments, each source segment comprising an addressable portion of the source object selected from a page, paragraph, line, table, table row, table cell, bounding region, heading, footnote, rate-tier row, benefit row, text span, or image region, and storing segment metadata comprising a page number, row identifier where applicable, column identifier where applicable, character offset where applicable, coordinate value where applicable, extracted text, parser version, and association with the cryptographic hash; generating numerical vector representations from extracted text, table labels, layout metadata, carrier identifiers, plan identifiers, coverage-line identifiers, or candidate fields of the source segments; retrieving, from a sample repository of previously processed benefit documents, one or more matched samples using the numerical vector representations and at least one matching factor selected from carrier similarity, plan-type similarity, coverage-line similarity, form-layout similarity, table-heading similarity, effective-date similarity, schema-version compatibility, tenant permission, or reviewer-quality score; creating an extraction instruction set comprising target text from the source segments, target segment identifiers, matched sample text, matched sample structured data, a canonical benefit schema identifying expected fields and permitted data types, normalization rules, and constraints requiring field values for the received benefit source document to be supported by target source segments or another approved origin rather than by matched sample values; causing an extraction model interface to obtain candidate structured benefit data comprising field names, field values, data types, proposed source locations, and confidence information for plan identity, carrier identity, benefit values, eligibility values, network values, rate-tier values, contribution values, or notice-applicability values; validating the candidate structured benefit data by comparing candidate field values against target source segments, normalizing currency, percentage, date, network, carrier, plan, coverage-tier, or rate-tier formats, assigning confidence values, creating source anchors for supported candidate fields, and detecting a matched-sample leakage condition when a candidate field value matches or substantially matches a value from a matched sample or prior-year record but lacks target-source support or another approved origin; routing to a review queue candidate fields that lack source anchors, conflict with another source document, violate a schema rule, fail a rate-calculation rule, have confidence below a configured threshold, or have an unresolved matched-sample leakage condition; storing, after automatic validation or reviewer approval, an approved normalized benefit record comprising approved field names, approved field values, source anchors, confidence values, reviewer status, version identifier, tenant identifier, company identifier, plan-year identifier, and source-document hashes; generating at least one employee benefit output from the approved normalized benefit record, the at least one employee benefit output selected from an employee benefit booklet, consolidated Portable Document Format document, flipbook, microsite, quick response code linked page, enrollment site, employee election sheet, premium breakdown sheet, annual legal notice, wrap summary plan description document, premium-only-plan document, broker compensation disclosure, carrier termination letter, request-for-proposal artifact, spreadsheet artifact, translation, or customer relationship management record; creating a source-anchor coverage map that associates required fields or output components of the at least one employee benefit output with source anchors, user-entered origins, imported origins, computed origins, template-derived origins, review-approved exceptions, or unresolved statuses; creating a manifest data record linking the at least one employee benefit output to source-object identifiers, source-document hashes, source anchors, the source-anchor coverage map, approved-record version identifier, template version, schema version, reviewer approval, rate-calculation parameter where applicable, publication setting, and output identifier; and preventing publication of a required employee-facing or employer-facing field when the source-anchor coverage map or manifest data record identifies the required field as unsupported, leakage-suspected, unresolved, stale, revoked, expired, or inconsistent with a current approved origin.

2. The computer-implemented method of claim 1, wherein parsing the source object comprises processing a Portable Document Format document having embedded text, scanned image text, table content, or carrier-provided fixed-layout content by extracting embedded text where available, applying optical character recognition to image text where needed, identifying table boundaries, associating deductible, copayment, coinsurance, out-of-pocket maximum, prescription, network, eligibility, or rate-tier values with row labels and column labels, and storing source anchors comprising page numbers, table identifiers, row labels, column labels, coordinate regions, extracted text spans, and source-document hashes.

3. The computer-implemented method of claim 1, wherein detecting the matched-sample leakage condition comprises computing a target-evidence score by searching the target source segments for an exact value, normalized value, synonym, display equivalent, table-position equivalent, or computed equivalent; computing a sample-leakage score by comparing the candidate field value to matched-sample values or prior-year values; and marking the candidate field as leakage-suspected when the sample-leakage score exceeds a configured threshold and the target-evidence score is below a configured threshold.

4. The computer-implemented method of claim 1, wherein the review queue displays for a candidate field at least a proposed value, normalized value, confidence value, target-source excerpt, target-source location, matched-sample context, prior-year value, validation message, downstream impacted outputs, and actions enabling a reviewer to approve, edit, reject, mark not applicable, request another document, select a controlling source, split a field, merge fields, or annotate an exception.

5. The computer-implemented method of claim 1, further comprising maintaining a renewal dependency graph having nodes representing source objects, source anchors, candidate fields, approved normalized benefit records, rate grids, census records, employer contribution scenarios, carrier responses, spreadsheet scenarios, output components, compliance templates, translation-rule sets, publication links, enrollment screens, employee election records, and manifest records; and traversing the renewal dependency graph after a change to identify affected downstream outputs and mark the affected downstream outputs as current, stale, review-required, regeneration-required, access-revoked, or unaffected.

6. The computer-implemented method of claim 1, further comprising updating the sample repository after permission checks and quality checks by storing corrected target text, corrected structured field values, source anchors, schema version, reviewer-quality indicator, permission metadata, sensitivity classification, exclusion rules, and quality-control status, while excluding employee identifiers, dependent identifiers, salary values, protected health information, or tenant-private source content from cross-tenant retrieval unless permitted by a tenant policy.

7. A multi-tenant employee benefit automation system comprising:
one or more processors; and
one or more non-transitory memories storing instructions that, when executed by the one or more processors, provide:
an identity and tenant-permission service configured to authenticate users, associate each user with a tenant organization, create tenant-scoped security contexts, and enforce tenant-specific permissions for companies, plans, documents, carrier invites, employer decisions, employee enrollment records, review actions, output types, and publication actions;
a source-document ingestion service configured to receive uploaded or imported benefit source documents and store each received document as an electronically stored source object comprising file bytes or storage object key, source-object identifier, tenant identifier, company identifier, plan-year identifier, document-type identifier, original filename, upload timestamp, uploader identifier, parser status, and cryptographic hash calculated from the file bytes;
a parsing service configured to convert source objects into source segments comprising addressable pages, paragraphs, lines, tables, table rows, table cells, headings, footnotes, coordinate regions, rate-tier rows, benefit rows, text spans, or image regions and to store segment metadata comprising page numbers, row identifiers, column identifiers, character offsets, coordinate values, extracted text, parser version, and source-document hash;
a sample-matching service configured to generate numerical vector representations from extracted text, table labels, layout metadata, carrier identifiers, plan identifiers, coverage-line identifiers, or field candidates and retrieve one or more matched samples from a sample repository of previously processed benefit documents using vector similarity and at least one of carrier similarity, plan-type similarity, form-layout similarity, schema-version compatibility, tenant permission, or reviewer-quality score;
an extraction-instruction service configured to assemble target source text, target segment identifiers, matched sample text, matched sample structured data, expected schema field identifiers, permitted data types, normalization rules, and constraints requiring values to be taken from the target source object or another approved origin rather than from matched sample values;
an extraction model interface configured to provide the assembled extraction instructions to an extraction model and receive candidate structured benefit data comprising field names, field values, data types, proposed source locations, and confidence information;
a validation and review service configured to compare candidate field values against target source segments, normalize field values, assign confidence values, create source anchors, detect matched-sample leakage conditions, create source-anchor coverage-map records, and route unsupported fields, conflicting fields, missing fields, leakage-suspected fields, schema-invalid fields, rate-invalid fields, or fields having confidence values below configured thresholds to a review queue;
an approved normalized benefit data store configured to store approved plan, carrier, coverage, rate, contribution, eligibility, compliance, cost, source-anchor, confidence, reviewer-status, version, tenant, company, plan-year, source-anchor coverage-map, and source-document hash data;
a renewal dependency graph service configured to link source objects, source anchors, approved normalized benefit records, carrier responses, spreadsheet scenarios, generated output components, compliance templates, enrollment screens, publication links, and manifest records and to determine downstream effects of source, rate, contribution, template, approval, or publication changes;
output services configured to generate at least two output types from the approved normalized benefit data store, the output types selected from benefit booklets, annual legal notices, wrap summary plan description documents, premium-only-plan documents, broker compensation disclosures, request-for-proposal artifacts, spreadsheet artifacts, enrollment sites, microsites, translations, quick response code linked pages, customer relationship management records, election sheets, premium breakdown sheets, carrier termination letters, and flipbooks; and
a manifest, audit, and publication service configured to generate manifest data records linking generated outputs to source-object identifiers, source-document hashes, source anchors, source-anchor coverage-map records, approved-record versions, schema versions, template versions, reviewer approvals, output hashes, publication links, user identifiers, timestamps, access permissions, and dependency-graph status, wherein a publication gate prevents serving, exporting, or linking a generated output when a required field or component remains unsupported, leakage-suspected, unresolved, stale, expired, revoked, or inconsistent with a current manifest state.

8. The system of claim 7, wherein the system is deployed behind an edge service or load balancer and within a firewall or virtual private cloud boundary comprising at least one web or application server, at least one relational database, at least one object document store, at least one telemetry or security-event integration, and a key-management or secrets-management service;
wherein database access and object document store access are restricted to authenticated application-layer connections, signed worker capability tokens, or signed links; wherein direct public access to source objects and generated outputs in the object document store is disabled;
and wherein source documents or generated outputs are encrypted using tenant-scoped, company-scoped, source-object-scoped, or output-scoped encryption keys whose key identifiers are stored with source-object records or manifest data records.

9. The system of claim 7, wherein the output services include a carrier-facing request-for-proposal dashboard service configured to create carrier invite records, limit each carrier user to requested coverage lines, provide password-protected or tokenized access to selected source documents and questionnaire fields, receive carrier proposal documents or rate grids, store the received carrier proposal documents or rate grids as source objects, parse and validate carrier response values against submitted source segments, and record carrier status events comprising link opened, document downloaded, questionnaire started, upload completed, proposal submitted, clarification requested, proposal approved, proposal selected, proposal not selected, invite expired, or invite revoked.

10. The system of claim 7, wherein the output services include a dynamic online spreadsheet service configured to generate a scenario-driven web view from approved normalized benefit records, carrier-response fields, census records, rate grids, contribution formulas, selected coverage lines, class rules, display preferences, and employer-specific permissions; store each employer edit as a versioned spreadsheet scenario; calculate employer monthly cost, employer annual cost, employee monthly contribution, employee cost per pay period, total premium, plan participation assumption, or difference-from-current-plan values; and propagate an approved spreadsheet scenario to booklet, enrollment, election-sheet, premium-breakdown, microsite, and carrier-notification outputs.

11. The system of claim 7, wherein the output services include a rate and census calculation service configured to calculate age-banded premiums, composite-rate premiums, tier-based premiums, life benefit volume, disability benefit volume, employer contributions, employee payroll deductions, or total premium values using census participant data, rate-band rules, dependent-count rules, coverage-class rules, salary-based benefit rules, age-reduction schedules, contribution formulas, pay-period counts, and rounding rules, and to store calculation traces identifying input fields, source anchors or approved origins, rule versions, intermediate values, output values, and reviewer status.

12. The system of claim 7, wherein the output services include a compliance-template and legal-notice service configured to maintain template identifiers, template versions, jurisdictions, plan-year applicability, employer-size conditions, plan-type conditions, coverage-line conditions, prescription-drug-coverage conditions, wellness-program conditions, effective dates, last-reviewed dates, official-source references, tenant override statuses, required input fields, output-format rules, and stale-template flags, and wherein a scheduled freshness process identifies generated outputs whose manifest records reference a stale template and requires regeneration, reapproval, republication, or blocking of affected compliance documents or microsite components.

13. The system of claim 7, wherein the renewal dependency graph service and the output services are further configured to manage an employee-benefit renewal project through request-for-proposal, proposal comparison, booklet generation, compliance-document generation, microsite publication, and enrollment preparation phases by:
creating, for a tenant organization, company, and plan year, a renewal project record comprising selected coverage lines, renewal dates, permitted users, phase states, requested output profiles, company data, contact data, branding settings, and publication settings;
receiving source documents, census data, current plan data, rate grids, prior-year outputs, carrier contact selections, employer contribution inputs, and legal-notice inputs associated with the renewal project;
creating one or more carrier invite records for a request-for-proposal phase, each carrier invite record identifying a carrier, one or more requested coverage lines, carrier contact version, due date, access scope, required questionnaire fields, permitted source documents, permitted upload types, password or token requirement, expiration setting, and status state;
providing a carrier-facing dashboard for each carrier invite record that displays only source documents, census segments, questionnaire fields, and project information permitted by the carrier invite record and tenant-scoped security context;
receiving carrier response documents, quote spreadsheets, plan summaries, proposal notes, or rate grids through the carrier-facing dashboard and storing each received carrier response item as a source object associated with the renewal project;
extracting, normalizing, source-anchoring, and reviewing carrier response fields into approved normalized benefit records or review-required candidate fields;
generating a dynamic online spreadsheet or proposal-comparison web view from approved normalized benefit records, carrier response fields, rate grids, census data, and employer contribution formulas;
receiving an employer decision that approves selected plans, contribution rules, display settings, or spreadsheet scenario values;
storing the employer decision as an approved spreadsheet scenario version;
using the approved spreadsheet scenario version and approved normalized benefit records to generate or update at least one benefit booklet, compliance document, microsite component, enrollment screen, election sheet, premium breakdown sheet, carrier-notification record, or customer relationship management renewal status;
creating or updating a renewal dependency graph that links the carrier invite records, carrier response source objects, approved normalized benefit records, spreadsheet scenario version, generated outputs, publication links, and manifest records; and
using the renewal dependency graph and manifest records to determine which downstream outputs require review, regeneration, revocation, expiration, or republication when a source document, carrier response, rate value, contribution rule, employer decision, compliance template, approved-record version, or publication setting changes.

14. The system of claim 13, wherein providing the carrier-facing dashboard comprises generating a protected link for a carrier user, verifying a password, signed token, or authenticated session, displaying a requested coverage-line-specific document package, allowing the carrier user to upload response documents and enter questionnaire answers, preventing access to coverage lines not included in the carrier invite record, and recording status events for invite sent, link opened, document downloaded, questionnaire started, upload completed, proposal submitted, clarification requested, proposal approved, proposal selected, proposal not selected, invite expired, or invite revoked.

15. The system of claim 13, wherein generating the dynamic online spreadsheet or proposal-comparison web view comprises creating one or more spreadsheet scenarios that store selected plan identifiers, hidden-plan settings, hidden-row settings, hidden-column settings, employer contribution percentages, fixed-dollar employer contribution amounts, class-specific contributions, tier-specific contributions, census-scope selections, rating assumptions, waiver assumptions, renewal-status fields, display labels, and calculated employer and employee cost values.

16. The system of claim 13, wherein the renewal dependency graph service and the output services are further configured to display a unified renewal dashboard showing phase states, missing fields, review queue items, carrier response status, spreadsheet scenario status, booklet status, compliance-document status, microsite publication status, enrollment setup status, stale-output warnings, source-document changes, legal-notice freshness warnings, and publication-gate blocking reasons, and to allow an authorized user to resolve or approve items from the unified renewal dashboard.

17. A non-transitory computer-readable storage medium storing instructions that, when executed by one or more processors of an employee benefit automation platform, cause the one or more processors to perform operations comprising:
maintaining, for a tenant organization, company, and plan year, an approved normalized benefit record comprising approved benefit fields, rate fields, contribution fields, eligibility fields, compliance fields, source anchors, confidence values, reviewer status, source-document hashes, and an approved-record version identifier;
maintaining a source-anchor coverage map that identifies, for required employee-facing, employer-facing, carrier-facing, or agency-facing values, whether each required value is supported by a source anchor, user-entered origin, imported origin, computed origin, template-derived origin, review-approved exception, or unresolved status;
generating, from the approved normalized benefit record, at least one publication artifact selected from an enrollment site, microsite, benefit booklet, dynamic online spreadsheet, request-for-proposal package, employee election sheet, premium breakdown sheet, legal notice, compliance document, translated output, or quick response code linked page;
creating a manifest data record for the at least one publication artifact, the manifest data record identifying source-document hashes, source anchors, source-anchor coverage-map version, approved-record version identifier, schema version, template version, rate-calculation rule version where applicable, spreadsheet scenario version where applicable, translation-rule-set version where applicable, generated-output identifier, output hash, publication setting, and access scope;
creating or validating a publication access record, signed link, employee token, employer token, carrier token, or authenticated session based on the tenant organization, company, user scope, employee scope where applicable, carrier invite scope where applicable, approved-record version identifier, manifest data record, publication setting, expiration time, revocation status, password requirement, device restriction, network restriction, token hash, or cryptographic signature;
receiving a request to access the at least one publication artifact;
evaluating a publication gate that compares current source-document hash, current approved-record version, current source-anchor coverage-map version, current schema version, current template version, current rate-calculation rule version, current spreadsheet scenario version, current translation-rule-set version, current review-queue state, current legal-notice template status, current publication setting, and current access-token status to corresponding values in the manifest data record and publication access record; and
preventing access to a required value or component of the at least one publication artifact when the publication gate identifies the required value or component as lacking a source anchor or approved origin, unresolved in a review queue, leakage-suspected, stale, expired, revoked, outside the permitted access scope, or inconsistent with the manifest data record.

18. The non-transitory computer-readable storage medium of claim 17, wherein the operations further comprise collecting, through an enrollment site generated from the approved normalized benefit record, at least one employee election, waiver selection, dependent entry, acknowledgment, or confirmation entry; storing the collected entry in an enrollment record or customer relationship management record associated with the tenant organization, company, employee, plan year, selected plan, and approved-record version identifier; and generating an employee election sheet or premium breakdown sheet that combines plan options, employee elections, waiver selections, dependent entries, rate-tier values, contribution formulas, number of pay periods, employer contributions, employee payroll deductions, signature fields, and date fields.

19. The non-transitory computer-readable storage medium of claim 17, wherein the operations further comprise applying a tenant-specific data-egress policy before transmitting source text, source segments, enrollment data, employee data, dependent data, census data, rate data, generated output data, or audit data to an external parsing, extraction-model, translation, payment, email, payroll, carrier, analytics, monitoring, or document-signature service, the data-egress policy identifying an approved endpoint, permitted data classes, field-minimization rules, redaction rules, tokenization rules, retention settings, model-use restrictions, sample-library restrictions, and tenant-consent requirements; redacting, tokenizing, omitting, or withholding data not permitted for the approved endpoint; and recording a data-transfer audit event identifying the endpoint, data class, policy version, tenant identifier, user or service principal, source object where applicable, approved-record version where applicable, manifest identifier where applicable, and time of transmission.

20. The non-transitory computer-readable storage medium of claim 17, wherein the operations further comprise writing audit records and manifest records to an append-only or hash-linked log, each audit record comprising event type, actor, role, security context identifier, tenant identifier, company identifier, affected object identifier, source-document hash where applicable, approved-record version where applicable, manifest identifier where applicable, generated-output hash where applicable, before-and-after values where applicable, timestamp, event hash, and prior-event hash, and using the append-only or hash-linked log to detect missing, modified, reordered, or unauthorized audit events and to support revocation, regeneration, expiration, or revalidation of only output components affected by a changed source document, approved-record version, source-anchor coverage-map version, template version, rate-calculation rule version, translation-rule-set version, publication setting, or access record.
